(19) United States
(12) Patent Application Publication
(10) Pub. No.: US 2025/0128510 A1
(43) Pub. Date: Apr. 24, 2025

(54) METHOD AND DEVICE FOR TRANSFERRING A TRANSFER LAYER OF A TRANSFER FILM ONTO A SUBSTRATE

(71) Applicant: LEONHARD KURZ Stiftung & Co. KG, Fürth (DE)

(72) Inventor: Ulrike Plaia, Veitsbronn (DE)

(21) Appl. No.: 18/939,725

(22) Filed: Nov. 7, 2024

Related U.S. Application Data
(62) Division of application No. 17/627,246, filed on Jan. 14, 2022, now abandoned.

(30) Foreign Application Priority Data
Jul. 18, 2019 (DE) 102019119535.7

(51) Int. Cl. B41F 16/00

(52) U.S. Cl. CPC B41F 16/002

(57) ABSTRACT

An offset printing device for transferring a transfer ply of a transfer film to a substrate, wherein the printing device has a first printing unit, which has a first transfer unit including a transfer cylinder with a transfer medium and a first substrate cylinder, wherein the first transfer unit of the first printing unit is designed in such a way that a first adhesion promoter is transferred from the transfer medium to a first region of the surface of the substrate, and a corresponding method.

### CROSS-REFERENCE TO RELATED APPLICATIONS

This application is divisional of U.S. patent application Ser. No. 17/627,246, filed Jan. 14, 2022, which is a national stage application based on International Application filed under the Patent Cooperation Treaty, PCT/EP2020/069021, filed Jul. 6, 2020, which claims priority to DE 102019119535.7, filed Jul. 18, 2019.

### BACKGROUND OF THE INVENTION

The invention relates to a printing device, in particular an offset printing device, for transferring a transfer ply of a transfer film to a substrate, and a method for transferring a transfer ply of a transfer film to a substrate by means of a printing device, in particular an offset printing device.

It is known to transfer transfer plies to a substrate by means of cold stamping. Here, it is further known, for cold stamping, to print a cold glue as adhesion promoter onto a substrate, onto which a transfer film with a transfer ply is then unrolled, wherein only the regions on which the cold glue was printed as adhesion promoter are transferred.

WO 9217338 A1 describes a film printing method and a film transfer machine which are used to lay a transfer layer of a transfer film on an underlay, wherein the transfer layer remains adhering the transfer layer to the underlay partially or over its surface after a subsequent release of the transfer film.

Offset printing machines are widely used for printing the cold glue, in particular in the case of cold stamping. However, high demands for the optical quality of the surface of the transferred transfer ply are as a rule not achievable by means of cold stamping in offset printing.

Further, flexographic printing machines are also used for printing the cold glue in the case of cold stamping.

### SUMMARY OF THE INVENTION

An object of the present invention is therefore to specify an improved printing device, in particular an improved offset printing device, for transferring a transfer ply of a transfer film to a substrate, as well as a method for transferring a transfer ply of a transfer film to a substrate by means of a printing device, in particular an offset printing device.

The object is achieved by a printing device, in particular offset printing device, for transferring a transfer ply of a transfer film to a substrate. Here, the printing device has a first printing unit, which has a first transfer unit comprising a transfer cylinder with a transfer medium and a first substrate cylinder. The first transfer unit of the first printing unit is designed in such a way that a first adhesion promoter is transferred from the transfer medium to a first region of the surface of the substrate.

The object is further achieved by a method for transferring a transfer ply of a transfer film to a substrate by means of a printing device, in particular an offset printing device. The method here comprises the following step: transferring a first adhesion promoter by means of a first printing unit. The first printing unit here has a first transfer unit comprising a transfer cylinder with a transfer medium and a first substrate cylinder, wherein the first adhesion promoter is transferred from the transfer medium to a first region of the surface of the substrate.

For example, a printing device which is as flexible as possible with regard to the printable inks, adhesion promoters and transfer plies that can be applied as well as the optical properties of the transfer plies and a corresponding method are herewith made possible. By means of such a printing device, in particular such an offset printing device, for example a more highly fluid adhesion promoter, for example with Newtonian or almost Newtonian behavior, and/or with particularly low tackiness and/or viscosity, can be printed for the cold stamping. It is thus achieved for example that the transferred transfer plies can meet higher demands for the optical quality of the surface of the transferred transfer plies, for example a higher gloss, a greater smoothness and/or a more appealing mirror effect.

Gloss is in particular an optical property of a surface, for example the surface of the transfer ply, preferably in the first region, to reflect light, preferably specularly, preferably completely or partially. If a surface is not glossy, in particular because it reflects light diffusely, this is preferably called matteness. Like color for example, the gloss is preferably a property which contributes in particular to the visual appearance of a surface. Gloss is in particular a sensory impression and therefore preferably dependent on the observer. In order to make the gloss of surfaces technically comparable, reflectometers are preferably used. Gloss results in particular both when a directed and/or focused illumination is effected, preferably on a surface, for example with a directed point light source or a spot, and when the surface reflects preferably specularly. As a result, every point of the surface preferably appears with different degrees of brightness from different observation angles, and in particular light reflections preferably change with a movement of the observer. A surface preferably has a very glossy effect if the brightness of a point differs, preferably greatly, in particular from two different observation positions, for example for each eye in the case of binocular vision. Matteness results in particular when the surface reflects the light preferably diffusely or when there is preferably a diffuse illumination overall. In particular in the latter case, thus in particular when there is a diffuse illumination overall, it preferably cannot be distinguished whether it is a glossy or a matte surface.

Gloss is in particular defined physically, preferably as the quotient of the portion of the luminous flux incident on a surface, preferably the above-named surface, that is reflected in a directed manner and the portion that is reflected diffusely. The gloss, in particular the quotient of the portion of the luminous flux incident on a surface, preferably the above-named surface, that is reflected in a directed manner and the portion that is reflected diffusely is preferably determined quantitatively with gloss meters.

If in particular the color of the reflected light also changes with the observation angle, then iridescence is preferably referred to.

Glimmer, glitter and/or sparkle effects are included in particular in the special forms of gloss, which is preferably brought about by local, high-gloss, small regions of surface, such as is preferably also typical for the variously mounted crystal surfaces of the minerals of the mica group, but particularly preferably also for ice and/or for the reflections on finely structured surfaces such as water, and/or metal foil shreds (glitter) and/or metallic effect pigments in a coating agent, such as for example metallic varnishes.

This higher optical quality is achieved in particular by means of the printing device, in particular the offset printing device, and the method, wherein in particular the maximum possible resolution of the transfer ply on the substrate during the transfer of the transfer ply of the transfer film to the substrate, in particular in the form of a cold film transfer, can furthermore be achieved. Here, a particularly good adhesion is in particular also achieved.

Further, the advantage is achieved in particular that the range of the printing inks and/or adhesion promoters that can be printed by means of the printing device, in particular the offset printing device, and thus in particular the flexibility thereof, is increased. Here, for example, the set-up times which are incurred for changing the printing ink to be printed and/or the adhesion promoter to be printed are also reduced. In particular, the advantage is thus achieved that the offset printing devices used more often or which are more popular can be modified in such a way that no further printing device is necessary in order to guarantee a degree of flexibility of production.

Advantageous embodiments of the invention are described in the dependent claims.

The transfer ply is preferably formed detachable from a carrier film of the transfer film.

By a “ply” and/or “layer” is preferably meant here a substantially flat structure, which can itself in turn preferably consist of several layers. It is for example a film or a circuit board. Alternatively, however, more complex three-dimensional geometries are also possible.

Such a layer and/or ply does not necessarily represent a standalone component, for example a transfer ply is also formed by vapor deposition of a metal layer on another layer, preferably a vaporizable varnish layer. The transfer film is preferably a cold stamping film and/or cold transfer film.

By an adhesion promoter is preferably meant here an adhesive and/or a glue. The first adhesion promoter here is in particular a cold glue and/or cold film glue. It is also possible for the transfer ply to have one or more further adhesion-promoter layers, preferably between further layers of the transfer ply, for increasing the cohesion of the transfer ply.

The printing device, in particular the offset printing device, is in particular a printing device, in particular an offset printing device, for transferring a transfer ply of a transfer film to a substrate with a cold film transfer device. The method for transferring a transfer ply of a transfer film to a substrate by means of a printing device, in particular an offset printing device, is in particular a cold film transfer method for transferring a transfer ply of a transfer film to a substrate by means of a printing device, in particular an offset printing device. The method is preferably carried out in an inline process.

Only a small amount of back splitting or substantially no back splitting advantageously takes place during the transfer of the first adhesion promoter from the transfer medium to the substrate.

In particular, in the case of a small amount of back splitting and/or immediately after the transfer of the first adhesion promoter from the transfer medium to the substrate, only very little adhesion promoter or, in the case of substantially no back splitting, substantially no adhesion promoter remains on the transfer medium. For example, this can preferably be achieved with a high surface tension and/or low viscosity of the first adhesion promoter. Preferably, the surface of the adhesion promoter which was applied to the substrate is hereby advantageously only very slightly roughened by a back splitting process. It is thus possible to apply a transfer ply to the correspondingly smooth first adhesion promoter, wherein the transfer ply then has a particularly high gloss and/or a particularly high level of smoothness.

By back splitting is preferably meant here a separation of a layer of a printing ink, for example an offset printing ink, and/or an adhesion promoter, for example the first adhesion promoter and/or a cold glue, from itself, wherein in particular the cohesion of the printing ink and/or the adhesion promoter is overcome. In other words, it means in particular the separation of a layer and/or a film of a printing ink and/or an adhesion promoter into two layers.

The back splitting is preferably set to be as small as possible. Here, by a small amount of back splitting is meant in particular that preferably a back splitting takes place wherein, however, the influence on the surface roughness of the first adhesion promoter, in particular after the transfer to the first region of the surface of the substrate, is small.

It is also advantageous that the first adhesion promoter has a Newtonian behavior or an almost Newtonian behavior. In particular, the behavior is measured in a state which exists before the first adhesion promoter is delivered to the first transfer unit and/or while the first adhesion promoter is being transferred to the substrate.

In particular through Newtonian behavior or almost Newtonian behavior, it is advantageously possible for the first adhesion promoter to run after the transfer to the substrate. For example, the surface of the adhesion promoter hereby smooths out before the application of the transfer ply, in particular by itself without external influences. Thus, in particular, the smoothness and/or the gloss of the first adhesion promoter, and thus preferably also the transfer ply applied later, is increased.

Here, it is expedient that the first adhesion promoter has a viscosity, preferably a dynamic viscosity, in the range of from 200 mPa·s to 5,000 mPa·s, preferably in the range of from 500 mPa·s to 2,000 mPa·s, further preferably in the range of from 500 mPa·s to 1,500 mPa·s. The viscosity, in particular the dynamic viscosity, here is preferably measured in a state which exists before the first adhesion promoter is delivered to the first transfer unit and/or while the first adhesion promoter is being transferred to the substrate. In the case of the viscosity, in particular dynamic viscosity, indicated in the above range it can in particular also be an average value, around which in particular tolerance values vary.

Such a viscosity guarantees in particular an optimum wetting of the transfer medium and/or the substrate. A higher viscosity leads, for example, to a poor running of the adhesion promoter and/or to a poor surface smoothness, which preferably directly impacts the gloss of the transfer ply, preferably after the transfer ply has been applied to the substrate with the adhesion promoter.

Viscosities are preferably indicated in pascal-seconds, abbreviated to (Pas or Pa·s). Other data are given for example in poise. Here, 1 Pas preferably corresponds to 10 poise.

To determine the viscosity, the latter is preferably measured at a temperature of 20° C. In the case of a simple flow behavior, for example in the case of homogeneous liquids, the viscosity is preferably measured by means of a rotational viscometer or by means of a rheometer.

To measure the viscosity of Newtonian fluids and/or highly fluid or low-viscosity liquids, rotational viscometers are preferably used, which preferably comprise a spindle which is rotated in a container. The spindle is preferably suspended on a torsion wire, which twists proportionally to a rotational resistance in particular at a defined rotational speed. The rotational resistance is preferably directly proportional to the viscosity. For such rotational viscometers, spindles of different design can be used, for example spindles for paper-coating inks, paints and for liquid printing inks and/or adhesion promoters, in particular low-viscosity printing inks and/or adhesion promoters. It is preferably calculated from the effort and the device geometry what shearing forces prevail in each case.

In physics, usually, the values are preferably plotted in a graph which indicates the shear rate and/or rotational speed on the x axis and the shear stress on the y axis. The graphs are preferably also called rheograms. Here, in particular, the slope of the curve reflects the viscosity of the liquid and/or of the printing ink and/or of the adhesion promoter. In the case of a simple flow behavior and/or Newtonian behavior, the slope is thus preferably constant. In other words, the viscosity remains in particular the same and/or constant when the shear rate increases, and the shear rate preferably increases linearly when the shear stress increases.

The viscosity, in particular the dynamic viscosity, of the first adhesion promoter thus preferably deviates from a constant viscosity, in particular a constant dynamic viscosity, and/or a Newtonian behavior, at most with a tolerance in the range of from 50 mPa·s to 250 mPa·s, preferably in the range of from 50 mPa·s to 200 mPa·s, preferably in the range of from 50 mPa·s to 150 mPa·s, wherein the constant viscosity, in particular the constant dynamic viscosity, is preferably an average value around which the tolerance values vary.

In particular, Newtonian liquids are widespread in nature, wherein, for simplification, the statement can preferably be made that all single-phase liquids, thus preferably not emulsions or suspensions, with a simple molecular structure are Newtonian. These are, for example, water, benzine, viscous mineral oils and glycerol. The first adhesion promoter is preferably single-phase, for example.

It is further possible for the speeds of the thermal molecular motion to be higher at a higher temperature of a system. In particular, the braking force of molecules which, in a model consisting of many molecular layers, preferably switch from one molecular layer into an adjacent molecular layer decreases because they also come across ever higher inherent proportions in the direction of flow. The viscosity of a printing ink and/or of an adhesion promoter with Newtonian behavior preferably decreases in the case of an increasing temperature.

Further viscometers are, for example, falling-piston viscometers, falling-ball viscometers and flow cups. The viscosity, preferably the dynamic viscosity, is determined in particular via force, speed and/or time-of-fall measurements.

In the case of a falling-piston viscometer, for example, a lacquer sample, a printing ink sample and/or an adhesion promoter sample is painted over an eyelet of a thermostatted holder. Then a falling piston, in particular that passes precisely through the eyelet, is preferably allowed to slide through the eyelet. Based on the time of fall of the falling piston, the viscosity, preferably the dynamic viscosity, of the lacquer sample, printing ink sample and/or adhesion promoter sample, which in particular represents a retarding paste-like test sample, is preferably determined here.

In the case of a falling-ball viscometer, the time of fall and/or the falling speed of a ball in the printing ink and/or the adhesion promoter is preferably determined, in particular whereby the viscosity, preferably the dynamic viscosity, is determined.

To determine the viscosity, in particular the dynamic viscosity, the following measurement method is particularly preferably carried out with a flow cup, which is preferably used for flexographic printing inks, for gravure printing inks and/or printing varnishes. In the case of the flow cup method, a flow cup is dipped in a substance to be measured, in particular in a liquid or printing ink to be measured and/or in the adhesion promoter to be measured. Then the flow cup is removed again from the substance to be measured, in particular the liquid or printing ink to be measured and/or the adhesion promoter to be measured. The flow cup preferably has a defined geometry, and preferably has a hole with a defined geometry in its base. The substance to be measured, in particular the liquid or printing ink to be measured and/or the adhesion promoter to be measured, flows in particular out of the hole and preferably forms a stream. The time until the stream breaks is preferably measured. In particular, the period of time between the flow cup being removed and the stream breaking is measured. Higher-viscosity substances, in particular liquids, printing inks and/or adhesion promoters, here preferably require longer than low-viscosity substances, in particular liquids, printing inks and/or adhesion promoters. Here, it is possible to indicate the viscosity by means of the period of time in flow seconds.

Here, it is possible for the flow cup to comprise a rod for the dipping and for the removal. It is further possible for the flow cup to comprise a circular opening which is connected to a conical base opposite the opening in particular via a cylindrical lateral surface. The base preferably contains the hole, in particular in the center of the base in a top view of the base, wherein the hole is preferably circular. The hole is formed in particular of a nozzle. A suitable nozzle diameter is preferably chosen here depending on the viscosity class. For example, in the case of a flexographic printing ink and/or in the case of the first adhesion promoter, a nozzle diameter of 4 mm is preferably used. For a gravure printing ink, for example, a nozzle diameter of 3 mm is used.

It is also possible for a liquid not to have only a fixed, preferably constant, viscosity under all shear conditions, in particular in the case of otherwise identical conditions. Preferably, such a liquid is referred to as non-Newtonian. An example of this is an ideal plastic body, which has in particular a yield point. Here, a yield point is preferably a characteristic minimum force for tearing structures, in particular the tearing-off force. If a first, non-elastic deformation has taken place, an ideally plastic body preferably then behaves like a Newtonian liquid. Correspondingly, the viscosity here preferably remains a fixed substance variable.

In particular, there are also pseudoplastic bodies, which preferably make up one of the forms to be encountered most often. Pseudoplasticity is in particular also called shear-thinning behavior or structural viscosity. Here, in particular, the shear stress initially increases degressively in the case of a uniformly increasing shear rate, and then preferably approaches a constant increase or viscosity, wherein, in the case of increasing shear rate, the viscosity preferably decreases regressively and then preferably approaches a constant viscosity. Many technical processes are based on pseudoplastic behavior or are dependent thereon, for example toothpaste does not run out of the tube before the toothpaste is pressed out, and does not flow between the bristles of the brush. A further example is paints, which as far as possible do not drip off the brush, because they have a very high viscosity when transported by the brush. They can then be quickly made to flow on a surface, as the viscosity preferably decreases during painting. The viscosity then preferably increases again and the paint in particular does not run in drips.

In particular, there are also liquids which are dilatant. Here, the shear stress preferably initially increases regressively in the case of a uniform increase, and then in particular approaches a constant increase or viscosity, wherein the viscosity preferably initially increases degressively and then in particular approaches a constant viscosity.

In particular, cold film glues used until now in offset printing preferably have a non-Newtonian behavior or an almost non-Newtonian behavior. Due to the comparatively strong back splitting during the printing of the cold film glue in offset printing, in particular in the form of an offset cold film glue, and its high viscosity, a rough surface of the cold glue printed by means of conventional offset printing forms after the transfer to a printing substrate. This high viscosity, in particular also called structural viscosity or shear thinning, is the property of a fluid to show a decreasing viscosity preferably in the case of high shear forces; thus, in particular, the higher the shearing becomes, the more highly fluid the cold film glue becomes. Such cold film glues are therefore described in particular as “non-Newtonian glues”. In other words, the viscosity is preferably higher in the case of low shearing, in such a way that it is possible for a non-Newtonian cold glue preferably not to flow or run without an external shear action.

As soon as a shearing stops, for example because the shear stress falls below a yield point, thus for example after the transfer of a non-Newtonian cold glue to a substrate by means of an offset printing device, the printed cold glue in particular stays in position, and preferably no longer changes its size and in particular its shape, or changes them only very slightly. As the shear forces in particular also occur in the case of a closed surface area, the surface area is preferably not to be seen as homogeneous in terms of its surface. In particular, a “mountain and valley landscape” of the cold glue forms on the substrate due to this shear viscosity. During the application of the transfer ply to such a cold glue surface, the glue in the case of conventional offset printing is for example not completely smoothed, i.e. the “mountain and valley landscape” is preferably only minimally smoothed. In particular, this is directly reflected in the gloss achievable by means of printing, in particular offset printing.

The method is preferably carried out in such a way and the printing device, in particular the offset printing device, is preferably formed in such a way that the first adhesion promoter has a particularly good tackiness.

The tackiness of a printing ink and/or of an adhesion promoter is in particular also called “tack”. The tackiness preferably describes the internal cohesiveness, preferably the cohesion, of a cohesive quantity of liquid, for example a cohesive quantity of printing ink and/or adhesion promoter. By tackiness is thus preferably meant the resistance which opposes the splitting of a printing ink layer and/or adhesion-promoter layer. The tackiness of a printing ink and/or of an adhesion promoter is preferably independent of the surface on which the printing ink and/or the adhesion promoter is located. This means in particular that the tackiness describes the cohesion and not the adhesion. Nevertheless, it is possible in particular for interactions to prevail between the first adhesion promoter and components and/or surfaces, such as the first transfer medium and/or the anilox roller, for example as the distribution of the first adhesion promoter is influenced by the geometry and arrangement as well as the movement and deformation of such components and/or surfaces during operation.

Higher “tack” is caused for example by a rougher surface structure of the transfer medium, for which until now in particular the above-named printing or rubber blankets have been used. The more finely the surface of the transfer medium is ground, preferably the lower the “tack” is. In particular, here, a back splitting of the printing ink and/or of the adhesion promoter is less and the surface of the adhesion promoter is in particular less rough after the transfer of the first adhesion promoter to the first region of the surface of the substrate.

It has been shown that an optical appearance of a cold-transferred transfer ply on a substrate is often imperfect in the case of the use of conventional method parameters and in particular the printing or rubber blankets in offset printing. For example, a crack formation and the formation of defects in the transfer ply regions applied to the substrate occur, which leads in particular to a reduced gloss. A reason for this is, for example, a deposition weight of the cold glue that is too small and/or a principle-based high viscosity of the adhesion promoter. In particular, the back splitting during the transfer of the adhesion promoter to the substrate results in a relatively high surface roughness of the printed adhesion promoter. Among other things due to the high viscosity of the adhesion promoter, in particular the cold glue, the adhesion promoter “stands” and is roughly “separated”. If the film is now unrolled onto it, this has until now been effected in particular by means of relatively low pressure, with the result that for example no “planishing” of the cold glue is effected.

In particular, disadvantages of a high tackiness will be described below, wherein a high tackiness is associated for example with a high viscosity, but there are preferably still further influencing factors in addition to the viscosity.

On rollers, cylinders and/or transfer media arranged thereon, a film or a layer of the printing ink to be transported via them and/or of the adhesion promoter to be transported via them forms in particular. Rollers, cylinders and/or transfer media arranged thereon would in particular have to apply more force here in order to split the film. For example, a correspondingly larger amount of energy is converted into heat. A higher tackiness thus leads in particular to a stronger heating in the printing unit, in particular in the inking unit. The greater effort during the splitting of the film also leads in particular to stronger pick forces which are exerted on the printing substrate, in particular the substrate. The tendency of fibers or other particles to be picked out of the printing substrate, in particular the substrate, increases in particular correspondingly. In addition, due to the high tackiness, the adhesion promoter is in particular very roughly deposited, whereby for example the named “mountain and valley” landscape forms. It is also possible for sensitive material, in particular a multi-layered substrate, to break open and/or to be made to delaminate, thus preferably for the uppermost ply or layer to be made to split off from the rest of the substrate.

In particular, disadvantages of a low tackiness will be described below. One disadvantage of a low tackiness is in particular that the printing ink and/or the adhesion promoter splits more unfavorably due to the printing unit, in particular inking unit. The poorer splitting also leads for example to a smaller transfer of the printing ink and/or the adhesion promoter from a printing or rubber blanket to the printing substrate, in particular to the substrate. The layer thickness of the printing ink and/or adhesion promoter applied to the substrate is thereby in particular less thick, and as a result the printing ink and/or the adhesion promoter has for example a less strongly colored effect on the printing substrate, in particular the substrate. A formation of an emulsion of the printing ink and/or the adhesion promoter with water is in particular more unfavorable.

The printed design preferably has a sharper effect overall with a tacky printing ink and/or a tackier adhesion promoter. Preferably, “tackier” describes a higher tackiness of a printing ink and/or an adhesion promoter. The tackier the printing ink and/or the adhesion promoter is, preferably the “more acutely” a dot is printed. In other words, a dot of printing ink and/or adhesion promoter transferred to a substrate in particular has a higher edge definition and/or higher resolution in the case of a greater tackiness. Tackier printing inks and/or adhesion promoters will preferably be used for a stable printing process.

In particular, corresponding negative effects are prevented or minimized by the tackiness of the first adhesion promoter, wherein a still stable printing process is possible. In particular, the advantages are achieved that it is made possible to transfer the transfer ply to the first adhesion promoter, wherein the transfer ply can have a particularly high smoothness and/or a particularly high gloss. Further, in particular, pick forces which are exerted on the substrate are reduced. To reduce the tackiness, in offset printing to date with an inking unit, for example, water is emulsified into the printing ink, as water is preferably less intrinsically cohesive than ink. However, this can in particular not be carried out arbitrarily, as the ink would no longer be conveyable in an inking unit of a known offset printing unit in the case of a tackiness of a printing ink and/or an adhesion promoter that is too low, and in particular it would run off in an uncontrolled manner over the known inking rollers.

The first adhesion promoter advantageously has in particular a lower yield point than a printing ink and/or an adhesion promoter for conventional offset printing. The first adhesion promoter here flows for example at a lower shear stress.

Further, the tackiness is in particular an important influencing factor for all splitting processes of the printing inks and/or adhesion promoters in the printing device, in particular offset printing device, preferably thus for the transport and/or the conveying of the ink and/or the adhesion promoter by means of the printing device, for example by means of the first transfer unit and/or the first and/or second inking unit.

If, for example, a printing ink of normal tackiness and/or an adhesion promoter of normal tackiness is exchanged, for example in an offset inking unit, for one that is tackier, a higher optical density is preferably printed with otherwise unchanged machine settings. The tackier printing ink and/or the tackier adhesion promoter in particular splits better than the less tacky ones, i.e. the back splitting is less. Here, the printing ink and/or adhesion promoter is thereby preferably transferred better and in particular in a greater layer thickness to the printing substrate. As a result, the adhesion promoter and/or the printing ink gives for example a more strongly colored impression, preferably without there being a higher pigmentation.

If the adhesion promoter and/or printing ink transfer from a transfer medium, a printing blanket and/or rubber blanket to a substrate, for example to a piece of paper, is greater, for example is 48% instead of 40% of a layer of the adhesion promoter and/or the printing ink arranged between transfer medium, printing blanket and/or rubber blanket and substrate cylinder, then the adhesion promoter and/or printing ink stream which passes through, for example, the first transfer unit and/or an inking unit, in particular the first and/or second inking unit, is preferably increased. This is the case for example although a chamber doctor blade system and/or the opening of a first and/or second ink duct is unchanged.

In particular methods for determining the tackiness will be discussed in more detail below.

Physically, the tackiness preferably describes a force per surface area and is here measured in particular as a pressure in the SI unit pascals, or newtons per square meter. As in particular the physically precise measurement value is sometimes difficult to determine and is not necessary in practical use in printing technology, the following methods are preferably used.

For the mechanical practice- and process-oriented determination of the tackiness with the Tacko unit, a Tack-O-Scope from Rudolph Meijer's Drukinktfabriek N.V. is preferably used. A determined quantity of the printing ink and/or the adhesion promoter, in particular the first adhesion promoter, is preferably distributed on three rollers lying one over another. The axle of the outer roller is here connected in particular to force transducers. The outer roller is pulled along by the roller lying underneath in its running direction, preferably due to the resistance during the splitting of the printing ink and/or the adhesion promoter, in particular the first adhesion promoter. The force measured here is in particular converted by a measurement device into a manufacturer-dependent scale, and is further dependent on process variables such as the layer thickness, the temperature and the rotational speed. Thus, for example, the Inko-Tackomat from Prüfbau can indicate the tackiness both in 0 Inko to 42 Inko and in 0 Tacko to 700 Tacko. In addition to the two established methods, in addition to the Tack-O-Scope, the inkometer is preferably also mentioned.

The generation of the printing sample and/or adhesion promoter sample is preferably effected, in particular taking DIN ISO 2846-1 and ISO 2834 into account, on a sample printing device from Prüfbau. Here, a proof printing device is temperature-controlled for example to 30° C. The printing speed is preferably set to 1 m/s and the printing, in particular the transfer of the printing ink and/or the adhesion promoter, is carried out at 600 N/cm. The Shore A hardness of the printing plate here is preferably between 60° and 70° Shore. The time for a rubbing-in and an inking of the printing ink and/or the adhesion promoter is preferably 20 seconds in each case. After the rubbing-in of the printing ink and/or the adhesion promoter, in particular in the inking unit, a series of printing samples and/or adhesion promoter samples with different deposition is preferably obtained by repeated inking of the printing plate with subsequent generation of a proof. In particular, the tackiness of 1 ml printing ink and/or adhesion promoter is determined taking the standard ISO 12634 into account with an Inkomat from the manufacturer Prüfbau at a temperature of 30° C. after an inking time of 60 seconds and a measurement time of 3 minutes at a running speed of 100 m/min.

The tackiness can further also in particular be estimated manually. A tacky printing ink and/or a tacky adhesion promoter is here preferably described as “long”, because preferably long strands form during its splitting process, in particular during its back splitting. Correspondingly, printing inks and/or adhesion promoters with low tackiness are preferably also described as “short” or “buttery”. This relationship is preferably utilized in a simple test, the “finger test”. Here, a sample of the printing ink and/or the adhesion promoter is in particular pulled apart between two fingers and the time when the strand forming in this process tears is observed. A long strand here is in particular a sign of a high tackiness. When the printing ink and/or the adhesion promoter is pressed together and pulled apart again several times, a tackier printing ink and/or the tackier adhesion promoter preferably also generates a louder noise, in particular in the form of a smacking noise.

It is thus conceivable in particular that an offset printing ink and/or an offset adhesion promoter is tackier compared with the first adhesion promoter, in particular determined by the finger test.

It has been shown in particular that the method is carried out in such a way, and/or the printing device, in particular offset printing device, is formed in such a way, that the first adhesion promoter has as little surface roughness as possible on its surface facing away from the substrate, after the first adhesion promoter has been transferred to the substrate. As the first adhesion promoter is in particular still uncured and thus for example soft, viscous and/or not yet solidified in this state, a direct measurement of the surface roughness of the first adhesion promoter in this state is in particular not readily possible. However, it is possible in particular to infer the surface roughness of the first adhesion promoter or assess its influence, by measuring the smoothness and/or gloss and/or surface roughness of the transfer ply after the application of the transfer ply to the first adhesion promoter.

For example, a particularly high gloss of the transfer plies applied to the substrate with the first adhesion promoter is achieved. In particular, only greater surface roughnesses are achieved with conventional offset printing devices, for example because of the flow and deformation properties, in particular a yield point to be overcome, and/or because of the back splitting, which is preferably stronger and/or requires more effort, of the adhesion promoters printed in offset printing. For example, in the surface profile, peaks and troughs of the first adhesion promoter, which substantially stay in position for example in conventional offset printing, run, preferably flow, in particular because of a lower tackiness.

It is thus possible for the first adhesion promoter to be a flexographic printing glue and/or flexographic printing adhesion promoter and/or a flexographic cold film glue, and/or to be transferred to the substrate preferably in the form of a flexographic glue and/or flexographic printing adhesion promoter and/or flexographic cold film glue.

Further, it has proved to be advantageous if the printing device is formed in such a way and/or the method is carried out in such a way that the first adhesion promoter is transferred to the substrate with a deposition volume in the range of from 2 cm³/m² to 10 cm³/m², preferably in the range of from 2.5 cm³/m² to 7 cm³/m², and/or with a deposition weight of from 3 g/m² to 15 g/m², preferably in the range of from 4 g/m² to 8 g/m².

A corresponding deposition weight is preferably determined via the density from the deposition volume, or vice versa. In particular, the advantage is achieved that the flexibility of the printing device, in particular the offset printing device, is improved with regard to the printable deposition weights.

The transfer of the first adhesion promoter to the substrate is preferably carried out with a contact pressure, wherein the contact pressure is settable and/or is set preferably via the spacing, preferably in the form of a gap, of the transfer medium and/or the transfer cylinder with the transfer medium and the first substrate cylinder. This spacing is here in particular 0.00 mm. It is in particular also possible for this spacing to lie in the range of from −0.5 mm to +0.75 mm, preferably in the range of from −0.1 mm to +0.3 mm and/or to be able to be set in this range. These negative and positive values relate in particular to a basic setting of the first substrate cylinder relative to the transfer cylinder, in particular relative to the surface of the transfer medium, preferably also taking the layer size and/or layer thickness of the substrate into account. From this basic setting, the pressure on the substrate can now be reduced, in particular by setting negative values, e.g. −0.1 mm, and/or increased, in particular by setting positive values, e.g. +0.3 mm.

The transfer medium preferably comprises a carrier plate, which comprises or consists of in particular polyester, preferably PET, and/or metal, preferably aluminum, and/or which preferably has a thickness in the range of from 0.5 mm to 5 mm.

Here, it has proved to be advantageous that the transfer medium, in particular on the side of the carrier plate facing away from the transfer cylinder, has an outer layer which preferably comprises or consists of a photopolymer.

The transfer medium, in particular the outer layer of the transfer medium, here preferably comprises one or more motifs, which are preferably introduced into the transfer medium, in particular the outer layer of the transfer medium, photochemically, in particular by means of exposure to light and washing out, and/or in particular by means of milling, engraving and/or laser machining.

By motif is also meant in particular a pattern, in particular an endless pattern. One or more patterns and/or motifs are in particular selected from the group: a graphically formed outline, a figurative representation, an image, a symbol, a logo, a portrait, an alphanumeric character, a text, a grating and/or the like or a combination of one or more of the above motifs.

The first adhesion promoter is preferably transferred, by means of the transfer medium, to the substrate in the first region over part of the surface and/or partially, in particular in the form of one or more patterns and/or motifs.

Further, it is possible for the transfer medium, in particular the outer layer of the transfer medium, preferably at least one first motif of the one or more motifs, to have a grid width of at most 150 lpi, in particular of at most 120 lpi, and/or of at most 59 lines/cm, in particular of at most 47 lines/cm.

It is in particular possible for the first adhesion promoter to be transferred from the transfer medium, in particular from the outer layer of the transfer medium, to the substrate at least in regions with a resolution of at most 150 lpi, preferably of at most 120 lpi, and/or at most 59 lines/cm, preferably at most 47 lines/cm.

In particular, lpi stands for “lines per inch”. L/cm stands in particular for “lines per cm”. By the resolution is preferably meant here the number of grid cells per unit of extension of a print raster. A conversion is preferably possible with the relationships 100 L/cm=254 lpi and/or 1 L/cm=2.54 lpi or L/inch.

Alternatively or in addition, it is preferably possible for at least one second motif of the one or more motifs to be used, preferably for an application of a flexographic printing ink and/or an offset printing ink to the substrate.

The one or more motifs of the transfer medium, in particular the outer layer of the transfer medium, preferably comprise one or more lines with a minimum line thickness of 0.05 mm, in particular of 0.1 mm and/or a minimum dot with a smallest dimension of 0.05 mm, in particular of 0.1 mm. In other words, the one or more motifs are preferably formed of one or more raised regions, preferably wherein at least one of the raised regions has a width and/or length in the named range on its side facing away from the carrier plate.

It is hereby possible in particular for the first adhesion promoter to be deposited on the transfer medium with a line thickness of at least 0.05 mm, in particular at least 0.1 mm.

In particular, the advantage is achieved that the principle-based maximum resolution for transferring the transfer ply to the substrate can be achieved by means of the transfer medium, preferably wherein the maximum possible gloss of the transfer ply is increased after the transfer.

The resolution of the first adhesion promoter in particular for the case where a transfer ply of a transfer film is transferred to the substrate with the first adhesion promoter, wherein in particular in the case of a peeling-off of a carrier film of the transfer film only remains where the first adhesion promoter is applied, is thus preferably not lower than the maximum possible resolution in the case of a cold film transfer. In other words, a degree of adhesion between transfer ply and substrate is preferably necessary, which guarantees that, in the case of a peeling-off of the carrier film of the transfer film, the transfer ply remains on the substrate in the first region, whereby the resolution of the adhesion promoter is in particular limited. In particular, the advantage is thus achieved that, in the case of a constant maximum resolution, a higher gloss of the transfer ply on the substrate can be achieved with the first adhesion promoter.

In particular, extremely fine details are advantageously represented due to the high resolving power, wherein the carrier plate preferably guarantees a high dimensional stability and register accuracy.

By register or registration, or register accuracy or registration accuracy, is preferably meant a positional accuracy of two or more elements and/or layers, here in particular the transfer ply relative to the substrate.

The register accuracy ranges in particular within a predetermined tolerance and is in particular as low as possible. The register accuracy in the case of a transfer of several transfer plies of the several transfer plies and/or several webs of a transfer ply or several transfer plies relative to each other is preferably an important feature in order to increase the process reliability.

The positionally accurate positioning is effected in particular by means of markings, in particular by means of sensorially, preferably optically detectable registration marks or register marks. These markings, in particular registration marks or register marks, preferably either represent specific separate elements, regions, layers and/or plies or are preferably themselves part of the elements or regions or layers to be positioned.

Further, advantages result from the fact that in particular cost-intensive materials and/or processes can be used particularly “economically” and in a carefully targeted manner and can be processed by means of process conditions adapted thereto. This also results in cost savings as well as a reduction of the reject rate.

Further, it is expedient that the transfer medium has a thickness in the range of from 0.5 mm to 10 mm, in particular in the range of from 0.76 mm to 6.35 mm.

The transfer medium preferably further has a length in the range of from 500 mm to 2,000 mm, and/or a width in the range of from 500 mm to 1,500 mm. These measurements are in particular dependent on the dimensions of the respective substrate and the printing machine used.

Further, it is possible for the transfer medium, in particular at least one motif of the one or more motifs, to have a relief depth in the range of from 0.5 mm to 1.0 mm, in particular from 0.5 mm to 0.9 mm. The relief depth here preferably determines the height of the one or more raised regions, which in particular form the one or more motifs.

Further, it has proved to be advantageous in particular that the transfer medium, in particular the outer layer of the transfer medium, preferably the one or more motifs, has a surface roughness, preferably an Ra value, in the range of from 0.05 μm to 1 μm, in particular in the range of from 0.2 μm to 0.8 μm.

The surface of the transfer medium, in particular the outer layer, preferably the one or more motifs, is thus advantageously smooth enough to guarantee preferably a very good transfer of the first adhesion promoter, in particular wherein only a small dot gain takes place.

Due to such a roughness of the transfer medium, which is in particular small, the wettability of the transfer medium with the first adhesion promoter is preferably further improved. For example, a back splitting of the adhesion promoter can be prevented for the most part or completely. Further, it is hereby preferably guaranteed that the adhesion promoter does not run or drip in an uncontrolled manner on the transfer medium, and in particular pick forces acting on the substrate which are too strong are prevented.

Further, it has in particular proved to be advantageous that the transfer medium, in particular the outer layer of the transfer medium, has a hardness in the range of from 50 Shore A to 80 Shore A, in particular from 55 Shore A to 60 Shore A.

In particular, the transfer medium here is preferably suitable for printing flexographic printing inks and/or flexographic printing adhesion promoters. In particular, it is herewith possible for the transfer medium to comprise and/or to be a varnish plate and/or a varnish printing blanket and/or a flexographic printing block, and/or for the transfer medium to comprise or to be a varnish plate and/or a varnish printing blanket and/or a flexographic printing block in the case of the transfer of the first adhesion promoter from the transfer medium to the first region of the surface of the substrate. Here, it is furthermore conceivable that the transfer medium is and/or comprises in particular a varnish printing blanket, a varnish plate and/or a rubber blanket, which in particular transfers a second adhesion promoter from the first inking unit to the substrate, preferably if the first inking unit is in a coupled state.

The transfer medium makes it possible in particular to transfer the first adhesion promoter and/or second adhesion promoter to the substrate partially and/or over part of the surface.

Such a transfer medium preferably achieves the advantages of the first adhesion promoter, as the transfer medium makes the processing thereof possible in particular. The transfer medium here further achieves the advantage in particular that it makes in particular a partial transfer or a transfer in the form of one or more motifs of the first adhesion promoter to the substrate possible, wherein a conveyor element upstream of the transfer medium, for example the anilox roller, takes up the first adhesion promoter not yet in the form of the one or more motifs. In particular, for an upstream conveyor element, in particular the anilox roller and/or a chamber doctor blade system, design options are herewith preferably available, which in turn make it possible to transfer adhesion promoters with special requirements, for example a low viscosity of the first adhesion promoter.

It is advantageous in particular to use a first transfer unit comprising a transfer cylinder with a transfer medium in a printing device, in particular offset printing device. For example, the printing device, in particular the offset printing device, is hereby improved corresponding to the named advantages.

It is particularly preferably possible for the method to be carried out in such a way and/or for the printing device, in particular offset printing device, to be formed in such a way that the transfer ply, in particular measured after the carrier film of the transfer film has been peeled off, has a smoothness, in particular measured according to Bekk in accordance with DIN 53107:2016-05, preferably with a Bekk Smoothness Tester, preferably of the type 533 from Messmer Büchel, of at least 200 s and/or has a surface smoothness, in particular measured according to the Parker Print Surf (PPS) method, preferably using the air leak method according to DIN ISO 8791-4:2008-05, preferably by means of a Parker Print Surf PPS 90 tester from Messmer Büchel, in the range of from 0.05 μm to 1.5 μm, preferably in the range of from 0.1 um to 1 μm.

Further, it is possible for the method to be carried out in such a way and/or for the printing device, in particular the offset printing device, to be formed in such a way that the transfer ply, in particular measured after the carrier film of the transfer film has been peeled off, has a gloss, in particular, greater than 500 GU with a measurement geometry of 60° and/or greater than 100 GU with a measurement geometry of 85°, preferably measured with a device of the type “micro tri gloss” from Byk Gardner. These measurement devices serve in particular to determine the gloss level, preferably of varnish coatings, plastics, ceramic and/or metallic surfaces. The surface is in particular spotlighted at a defined angle and the reflected light is preferably measured photoelectrically, preferably by means of a reflectometer. The measurement device corresponds in particular to the standards DIN 67530, ISO 2813, ASTM D 523 and/or BS 3900 Part D5. For calibration, the device is preferably kept in a holder with the integrated glass standard. In particular, when switched on, a self-test is preferably automatically carried out, which tests for possible changes in the measurement signal, preferably against the stored calibration data. In particular with the “micro tri gloss” device, the gloss is preferably determined in gloss units or reflectance.

The “micro tri gloss” device has in particular the following important characteristic values:

| | | | |
|---|---|---|---|
| Measurement geometry | 20° | 60° | 85° |
| Measurement spot size (mm) | 10 × 10 | 9 × 15 | 5 × 38 |
| Measurement range | 0-2000 GU | 0-1000 GU | 0-160 GU |

Accuracy:

| | | | |
|---|---|---|---|
| Range | 0-100 | GU | 100-2000 GU |
| Repeatability | 0.2 | GU | 0.2% |
| Comparability | 0.5 | GU | 0.5% |

The measurement unit GU means “Gloss Unit”.

The gloss values determined are, in particular in the case of the measurement of the transfer ply, in particular the substrate with the transfer ply, preferably greater than 500 GU with a measurement geometry of 60° and/or greater than 100 GU with a measurement geometry of 85°.

The gloss, the smoothness and/or the surface smoothness of the transfer ply and/or of the substrate with the transfer ply is preferably measured in the first region, in particular measured on the surface of the transfer ply in the first region.

The substrate expediently has, in particular measured before the transfer of the first adhesion promoter to the substrate, a surface smoothness, preferably measured according to PPS 10, ISO 8791-4, in the range of from 0.5 μm to 2.0 μm, preferably with a tolerance in the range of from 0.01 μm to 0.2 μm. It is also possible for the substrate to have a gloss in the range of from 20% to 80%, preferably in the range of from 50% to 75%, in particular measured according to TAPPI® T480, preferably with the measurement device microgloss 75° from BYK Gardner, preferably at an angle of 75°.

Further, it is expedient that the substrate has a pick resistance, in particular measured before the transfer of the first adhesion promoter to the substrate, preferably measured according to ISO 3783:2006-07, preferably with the measurement device Amsterdam 5 (4 m/s) from IGT, of from 0.5 m/s to 4 m/s, in particular from 0.75 m/s to 4 m/s.

The pick resistance is in particular measured with a final speed of 4 m/s and preferably with a contact pressure of 350 N and preferably an IGT pick-test oil of average viscosity as test printing ink. Preferably five printed strips per direction are applied to the upper side of the substrate.

It has in particular proved to be advantageous that the substrate, in particular measured before the transfer of the first adhesion promoter to the substrate, has a penetration behavior in the range of from 0.9 OD to 1.3 OD (OD=Optical Density). The penetration behavior is measured in particular on a test printing device from IGT, preferably with one or more of the following properties and/or parameters:
Device: AMSTERDAM 5
Printing/Counter printing cylinders: Aluminum (50 mm wide)
Printing speed: 0.2 m/s
Contact pressure: 1,000 N
Counter printing time (start): 5 s
Counter printing paper: Reference paper Ka APCO (coated paper)
Test printing ink: IGT penetration test ink (cyan)
Number of printed strips: Three per direction on the upper side.

For example, the penetration behavior of specimens 3 to 6 is measured, wherein specimens 3 to 6 preferably have the following type:
Specimen 3: Paper substrate Ensocoat 2S, in particular wherein only two printed strips each, preferably two printed strips per direction, are evaluated,
Specimen 4: Paper substrate Invercote G,
Specimen 5: Paper substrate Performa White,
Specimen 6: Paper substrate Profigloss.

The evaluation of the penetration test is preferably effected by means of color density measurement, preferably with a GRETAG densitometer, on areas, in particular counter print areas, wherein a lower density, preferably a lower optical density, of the counter print means in particular that more printing ink has penetrated into the test paper. In particular, per area, preferably per counter print area, five individual values of the optical density are measured per area on each specimen. The following table shows possible results of a penetration test for three different specimens, in particular specimens 3 to 6, preferably of the above-named type.

| | | Penetration test, optical density of the areas | | | | | | | |
|---|---|---|---|---|---|---|---|---|---|
| | | on the counter paper | | | | | | | |
| | | Area A | | Area B | | Area C | | Area D | |
| Specimen | n | MW | SD | MW | SD | MW | SD | MW | SD |
| 3 | 10 | 1.16 | 0.13 | 1.16 | 0.14 | 1.11 | 0.15 | 1.03 | 0.20 |
| | | 1.08 | 0.12 | 1.08 | 0.14 | 1.04 | 0.16 | 0.95 | 0.16 |
| 4 | 15 | 1.18 | 0.13 | 1.17 | 0.15 | 1.13 | 0.17 | 1.09 | 0.23 |
| | | 1.20 | 0.10 | 1.18 | 0.12 | 1.13 | 0.14 | 1.11 | 0.16 |
| 5 | 15 | 1.09 | 0.08 | 1.03 | 0.10 | 0.96 | 0.12 | 0.90 | 0.15 |
| | | 1.10 | 0.10 | 1.02 | 0.13 | 0.97 | 0.12 | 0.90 | 0.15 |
| 6 | 15 | 1.26 | 0.09 | 1.24 | 0.10 | 1.18 | 0.12 | 1.12 | 0.15 |
| | | 1.23 | 0.11 | 1.20 | 0.13 | 1.15 | 0.14 | 1.10 | 0.16 |

By counter paper is preferably meant the counter printing paper, which is preferably the substrate. By area is preferably meant a counter print area.

The parameter n indicates in particular the number of individual measurements. The average value of the individual measurements is indicated in particular by the parameter MW. The standard deviation is preferably indicated by the parameter SD.

The tests show in particular that specimen 5 has the best results for the penetration behavior.

It is advantageous here in particular that the substrate is such that the first adhesion promoter in particular does not “penetrate”, i.e. sink in, too quickly. In other words, the first adhesion promoter for example does not seep into the substrate, or only seeps into it slowly.

Paper, card, plastic film, metal foil or a laminate comprising at least two of these materials is preferably used as material for the substrate. The substrate preferably has a surface that has been coated at least twice and is as smooth as possible, and it is preferably not very absorbent. Further, the substrate preferably has a grammage, in particular a specific weight, of between 70 g/m² and 350 g/m².

It is further expedient that the substrate is provided by means of a roll, in particular wherein the substrate is processed in a roll-to-roll process, and/or the substrate is processed in particular in sheets. The substrate is preferably formed flexible, with the result that it is processed in a roll-to-roll process preferably continuously or on a sheet printing machine, in particular sheet offset printing machine. Here, in particular, a band-shaped substrate wound onto and/or provided on a roll or a substrate in the form of individual printing sheets is used.

Further, it is possible for the substrate to comprise or consist of one or more and/or combinations of the following materials: chromo-sulfate board, chromo board, chromo duplex board, chromo triplex board, cast-coated chromo board, picture printing paper, semimatte coated paper, matte coated paper, gloss coated paper, non-waterproof label paper coated on one side, waterproof label paper coated on one side, cast-coated non-waterproof label paper, cast-coated waterproof label paper.

For example, the substrate has the following layer structure with layers comprising the materials, in particular in the following order:
Double coat
Sulfate pulp
Sulfate pulp
Sulfate pulp
Double coat.

Further, it is possible for example for the substrate to have the following layer structure with layers, in particular in the following order:
Triple coat
Sulfate pulp
CTMP layer
Sulfate pulp
Pigment coat.

It is in particular also possible for the substrate to have the following layer structure with layers, in particular in the following order:
Top coat
Middle coat
Precoat
Bleached chemical pulp
Bleached chemical pulp
Bleached chemical pulp
Pigment coat.

Further, it is possible for the substrate to be processed in sheets with processing speeds of from 3,000 sheets per hour to 20,000 sheets per hour, in particular 8,000 sheets per hour to 15,000 sheets per hour.

It has in particular proved to be advantageous that the first transfer unit further comprises an anilox roller which is formed in such a way that it transfers in particular the first adhesion promoter to the transfer medium of the first transfer unit. The anilox roller can preferably be coupled and decoupled. The first adhesion promoter is preferably transferred to the transfer medium of the first transfer unit by means of the anilox roller.

By “can be coupled and decoupled” is meant here in particular that a connection to the transfer medium, which makes a transfer of an adhesion promoter, in particular the first and/or second adhesion promoter, and/or a printing ink, from the component that can be coupled and decoupled, in particular the anilox roller, the chamber doctor blade system, the first inking unit and/or the first dampening unit, to the transfer medium possible, can be produced and removed. For the second inking unit and/or dampening unit, by “can be coupled and decoupled” is meant in particular that a connection to a pressing blanket and/or an offset printing blanket, which makes a transfer of an adhesion promoter, in particular the first and/or second adhesion promoter, and/or a printing ink, from the component that can be coupled and decoupled to the pressing blanket and/or an offset printing blanket possible, can be produced and removed.

This demonstrates, in particular, the advantage, which preferably arises due to the use of an adhesion promoter with one or more of the above-named properties, that by means of the anilox roller printing inks and/or adhesion promoters are preferably conveyed, the back splitting of which is preferably kept low and/or prevented owing to the influence on the gloss of these printing inks and/or adhesion promoters or a transfer ply applied thereto. For example, it is possible that the adhesion promoter will run down a roller preferably without such a shape in particular too quickly and thus in particular will not be processed reliably.

It is also possible for the first transfer unit further to comprise a chamber doctor blade system which is in particular formed in such a way that the first adhesion promoter is transferred from the chamber doctor blade system to the anilox roller, in particular wherein the chamber doctor blade system can be coupled and decoupled preferably together with the anilox roller.

It has in particular proved to be advantageous if the anilox roller has a pick-up volume in the range of from 10 cm³/m² to 30 cm³/m², in particular in the range of from 15 cm³/m² to 25 cm³/m², and/or in the range of from 6.45 BCM to 19.35 BCM, in particular in the range of from 9.67 BCM to 16.12 BCM. BCM is preferably the abbreviation for billion cubic microns. In particular, one BCM corresponds to 1.55 cm³/m². The deposition volume is for example 22 cm³/m² and/or 14 BCM. The glue density is for example 1 g/ml. One milliliter (ml) preferably corresponds to one cubic centimeter (cm³). One cubic centimeter per square meter (cm³/m²) corresponds in particular to 1 μm of layer thickness. Further data are given in particular in g/m² or ml/m².

Further, the anilox roller preferably has an engraving angle in the range of from 30° to 90°, in particular in the range of from 45° to 60°. In particular, it is possible for the anilox roller to have an engraving, preferably wherein the engraving comprises one or more of the engraving types selected from: truncated pyramids, cell, spherical cap, hachure, in particular line structure, hachure with wells and/or hexagonal shape or a combination thereof. The grid width of the anilox roller preferably lies in a range of from 20 L/cm to 200 L/cm, in particular in a range of from 40 L/cm to 100 L/cm, preferably in a range of from 40 L/cm to 80 L/cm. A transfer to the transfer medium over the whole surface is preferably guaranteed hereby. The grid width is preferably also called ruling.

The grid width preferably gives information about the spacing of the depressions or wells from each other. The number and the spacing of the wells here preferably give the ruling. If an anilox roller bears more wells, then in particular a targeted quantity of adhesion promoter, in particular first adhesion promoter, and/or printing ink is transferred, which preferably corresponds to a smaller pick-up volume.

Further, it has proved to be advantageous that the first adhesion promoter, in particular measured before, during or after the transfer of the first adhesion promoter to the substrate and/or before the application of the transfer ply to the substrate, has a sufficiently high surface tension.

In particular, a sufficient take-up, conveying and delivery of the first adhesion promoter by means of the anilox roller is guaranteed hereby. For example, a surface tension chosen not to be too low ensures that the first adhesion promoter preferably does not run out of the wells in an uncontrolled manner during the rotation of the anilox roller, before the surface of the first adhesion promoter comes into contact with the transfer medium.

The printing device preferably has a second printing unit, in particular which is connected to the first printing unit via a conveyor element. In particular, it is possible here for the conveyor element to be or to comprise a conveyor section for conveying the substrate, in particular wherein the substrate is processed in the form of rolls. It is furthermore possible for the conveyor element to be or to comprise a drum, in particular with substrate holders, for conveying the substrate, in particular wherein the substrate is processed in the form of sheets.

It is possible in particular for the second printing unit to have a second transfer unit comprising a pressing cylinder with a pressing blanket and a second substrate cylinder. The second transfer unit is in particular designed in such a way that the transfer ply is applied, from the pressing blanket, to the substrate with the first adhesion promoter transferred in the first region. It is possible here for the method preferably further to comprise the following step, in particular after the transfer of the first adhesion promoter to the substrate:
applying the transfer ply to the substrate by means of a second printing unit, which has a second transfer unit comprising a pressing cylinder with a pressing blanket and a second substrate cylinder, in particular wherein the transfer ply is applied, from the pressing blanket, to the substrate with the first adhesion promoter transferred in the first region.

The steps are preferably carried out in any desired order and/or in succession and/or also multiple times.

Preferably, the application of the transfer ply to the substrate with the first adhesion promoter transferred in the first region is preferably carried out with a contact pressure, wherein the contact pressure is settable and/or is set preferably via a spacing, in particular in the form of a gap, between the pressing blanket and the second substrate cylinder. This spacing lies in particular in the range of from −0.5 mm to +0.75 mm, preferably in the range of from −0.1 mm to +0.3 mm and/or can be set in this range. These negative and positive values relate in particular to a basic setting of the substrate cylinder, preferably of the second substrate cylinder, relative to the pressing cylinder, in particular relative to the surface of the pressing blanket, preferably also taking the layer size and/or layer thickness of the substrate into account. From this basic setting, the pressure on the substrate can now be decreased, in particular by setting negative values, e.g. −0.1 mm, and/or be increased, in particular by setting positive values, e.g. +0.3 mm.

Such a contact pressure can in particular be generated because of the properties of the first adhesion promoter and/or of the substrate. As a result, the advantage is achieved in particular that the transfer ply is applied particularly smoothly, preferably wherein a potential crack formation is reduced.

It is expedient here that the pressing blanket has a hardness in the range of from 50 Shore A to 90 Shore A, in particular in the range of from 70 Shore A to 90 Shore A. An advantage results here, preferably in combination with the properties of the first adhesion promoter, in particular because a higher contact pressure, in particular for planishing the transfer ply, is possible, wherein disadvantageous effects such as for example potential crack formation are not or are only slightly involved.

The pressing blanket preferably has a thickness in the range of from 1.5 mm to 2.5 mm, in particular from 1.7 mm to 2.0 mm.

Further, it is possible for the first and/or second printing unit to comprise a curing device for curing the first adhesion promoter. Here, a method is conceivable wherein the following step is preferably carried out:
curing the first adhesion promoter by means of the curing device.

The curing device is preferably arranged on the first and/or second substrate cylinder, in particular in such a way that during the curing of the first adhesion promoter the substrate is arranged between the curing device and the first and/or second substrate cylinder.

It is in particular possible herewith for the first adhesion promoter to be cured by means of irradiation during the curing, and in particular to be irradiated through the transfer film, preferably through the carrier film and/or the transfer ply of the carrier film.

Through the transfer of the first adhesion promoter to the substrate, a smooth deposition, in particular deposition of glue, is preferably already achieved, in particular before the transfer ply is applied with the pressing blanket. If, in particular, curing is still carried out here through the transfer ply with the carrier film, preferably with a PET film, then in particular the surface gloss of a transfer ply applied to the first adhesion promoter is still further improved.

Preferably, the first adhesion promoter is cured on a curing section of between 10 cm and 60 cm, in particular between 15 cm and 25 cm, and/or between 20 cm and 30 cm, in particular wherein the substrate with the transfer film is conveyed over the curing section by means of one or more first deflecting rollers. In particular, the curing device cures the first adhesion promoter on a curing section of between 10 cm and 60 cm, in particular between 15 cm and 25 cm and/or between 20 cm and 30 cm, in particular wherein the curing section comprises one or more first deflecting rollers, which are preferably designed in such a way that they convey the substrate with the transfer film in particular along the curing section.

For example, it has also proved to be advantageous that the first and/or second printing unit comprises a precuring device, which is arranged in particular in such a way that, preferably after, in particular immediately after, preferably 0.05 s to 0.2 s after, the transfer of the first adhesion promoter to the substrate and/or before the application of the transfer ply to the substrate with the first adhesion promoter transferred in the first region, the precuring device precures the first adhesion promoter.

It is herewith possible in particular for the following step to be implemented:
precuring the first adhesion promoter after, in particular immediately after, preferably 0.05 s to 0.2 s after, the transfer of the first adhesion promoter to the substrate and/or before the application of the transfer ply to the substrate with the first adhesion promoter.

The first adhesion promoter is preferably cured by means of the curing device during the curing after, in particular immediately after, preferably 0.05 s to 0.2 s after, the transfer of the transfer ply to the substrate with the first adhesion promoter transferred in the first region. It is thus expedient that the curing device is designed in such a way that it cures the first adhesion promoter after, in particular immediately after, preferably 0.05 s to 0.2 s after, the transfer of the transfer ply to the substrate with the first adhesion promoter transferred in the first region.

In particular, through the arrangement of the curing device and/or the precuring device, it is achieved that a compact design of the printing device is preferably achieved. Here, a conveyor section between first and second printing device is preferably simultaneously used as curing section. Further, it is hereby possible for example to save energy, in particular thermal energy.

The printing device, in particular the second printing unit, preferably comprises a peeling-off device, which is preferably formed in such a way that the carrier film of the transfer film is peeled off, in particular wherein the transfer ply remains on the substrate in the first region. This means in particular that the transfer ply only remains on the substrate where the first adhesion promoter has been and/or is being transferred.

It is herewith possible for the following step preferably to be implemented:
peeling off the carrier film of the transfer film in such a way that the transfer ply only remains on the substrate where the first adhesion promoter is transferred.

Here, it is advantageous that the curing device is arranged, in particular in the conveying direction of the substrate, before the peeling-off device and/or after the first transfer unit, in particular the transfer medium.

Preferably no curing device and/or precuring device is arranged after the peeling-off device in the conveying direction of the substrate and/or preferably no curing and/or precuring is carried out after the peeling-off of the carrier film of the transfer film.

It is herewith further advantageous that the curing, in particular in the conveying direction of the substrate, is carried out before the peeling-off of the transfer film and/or after the transfer of the first adhesion promoter to the substrate. In particular during the peeling-off of the carrier film, this advantageously preferably does not result in a pulling of the first adhesion promoter again and/or preferably does not result in a picking force on the substrate, the first adhesion promoter and/or the transfer ply. In particular, the smooth ply of the adhesion promoter and/or the transfer ply is preferably not negatively influenced thereby, and in particular the advantage is achieved that the smoothness and/or the gloss of the transfer ply is increased.

In particular, the second printing unit comprises a deflection device with one or more deflection stations, which is preferably formed in such a way that the transfer ply is fed through between the pressing cylinder and the second substrate cylinder repeated one or more times. The transfer ply is preferably applied to the substrate repeated one or more times and/or the carrier film of the transfer film is at least partially peeled off repeated one or more times and the transfer ply at least partially remains on the substrate with the first adhesion promoter in the first region.

The material of a transfer film is advantageously optimally utilized here through a multiple application of the transfer ply to the substrate. Here, it is also possible for the multiple application of the transfer ply to one or more substrates to take place.

The curing and/or the precuring is preferably carried out by means of an irradiation, selected from the group: UV irradiation, in particular by means of high pressure UV mercury vapor lamp, medium pressure UV mercury vapor lamp, low pressure UV mercury vapor lamp, low energy UV, and/or UV LED, and/or electron beams (E-Beam) or a combination thereof.

It is thus expedient that the curing device and/or the precuring device comprises one or more emitters selected from the group: UV emitters, in particular high pressure UV mercury vapor lamp, medium pressure UV mercury vapor lamp, low pressure UV mercury vapor lamp, low energy UV and/or UV LED emitters, and/or electron beam emitters (E-Beam emitters) or a combination thereof. By one or more emitters is meant here in particular one or more radiation sources. UV preferably stands for ultraviolet radiation.

It is in particular possible for the substrate and/or the first adhesion promoter to be irradiated with a wavelength in the range of from 250 nm to 410 nm, in particular in the range of from 310 nm to 410 nm, and/or in the range of from 365 nm to 405 nm, during the curing and/or during the precuring. It is expedient that the curing device and/or the precuring device irradiates the substrate and/or the first adhesion promoter with a wavelength in the range of from 250 nm to 410 nm, in particular in the range of from 310 nm to 410 nm, and/or in the range of from 365 nm to 405 nm.

During a curing by means of UV irradiation, liquid coating materials, for example varnishes, printing inks and/or adhesion promoters, in particular the first adhesion promoter, are preferably cured, which preferably change into a solid state within a few seconds via a chemical reaction. In particular in the case of varnishes, a solid and dry film is formed.

Preferably one or more radiation sources in the form of UV lamps are used as one or more emitters, wherein it is possible for doped, for example lead-, iron-, gallium- and/or thallium-doped, and/or undoped lamps, for example mercury vapor lamps and/or flashtubes, to be used as radiation source. UV radiation curing varnishes, inks and/or adhesion promoters or glues are preferably, for simplicity, referred to only as UV varnishes, UV inks and/or UV adhesion promoters or UV glues.

A high pressure mercury vapor lamp, in particular high pressure UV mercury vapor lamp, preferably emits UV radiation in particular at 254 nm, 296.73 nm, 313 nm, 335 nm, 365 nm (i-line) and 405 nm (h-line). All other wavelengths are preferably already in visible light and preferably play a subordinate or no role here. In other words, in particular, other wavelengths are also emitted, which preferably have only a small or no influence on the curing and/or precuring.

A medium pressure mercury vapor lamp, in particular a medium pressure UV mercury vapor lamp, preferably emits UV radiation in particular at 250 nm, 313 nm, 365 nm (i-line) and 405 nm (h-line). All other wavelengths are preferably already in visible light and preferably play a subordinate or no role here. In other words, in particular, other wavelengths are also emitted, which preferably have only a small or no influence on the curing and/or precuring.

A low pressure mercury vapor lamp, in particular a low pressure UV mercury vapor lamp, preferably emits UV radiation in particular at 254 nm and preferably has yet another emission line at 185 nm.

For example, with metal halides or gallium-, lead-, iron-, thallium- and indium-doped gas fillings are obtainable. They preferably supplement the emission spectrum with UV-A and/or blue, in order in particular to prevent the absorption of shorter-wavelength UV radiation by color pigments.

Furthermore, it is possible to use one or more UV LED lamps, which in particular have an emission spectrum between 365 nm and 405 nm, as one or more emitters.

For curing, UV LED emitters and/or UV LED systems preferably utilize the property of light emitting diodes (LEDs), which convert electrical current directly into light. They are based in particular on semiconductor compounds, which emit energy in the form of ultraviolet radiation or also visible light as soon as current flows through an LED in the conducting direction. Here, the polymerization is preferably brought about by the light or the radiation of the LED. In particular, the polymerization process in the case of a UV LED emitter and/or LED system is in principle identical to the known UV technique. One difference is in particular that an optimization of the chemistry in terms of the reactivity and the surface properties is effected. If said prerequisites are met on the part of the printing inks, varnishes, adhesion promoters, coatings or other printing material, then a UV LED emitter and/or UV LED system can preferably be successfully used e.g. in the printing device, in particular offset printing device.

UV LE preferably means low energy UV and is preferably also called “LE UV”. An immediate drying of the printing ink and/or of the adhesion promoter is in particular achieved with a UV LE emitter and/or an LE UV system.

By means of the curing, the substrate can for example be processed further immediately, and in particular no intermediate storage is required for drying the substrate with the adhesion promoter. Further, it is hereby possible to dispense with the use of powder. Moreover, the abrasion resistance is preferably increased, with the result that the transfer ply in particular does not necessarily require a protective varnish layer. Moreover, it is possible for preferably no additional IR drying (IR=infrared, here preferably infrared radiation) to be used, whereby for example energy costs can be saved.

Further, in particular, the process reliability is increased, and preferably the optical quality is increased. In addition, in particular, a penetration of the adhesion promoter, in particular into the substrate, is reduced and particularly good finishing possibilities preferably arise, as well as for example the possibility of producing cut ink surfaces and/or of producing cut adhesion promoter surfaces.

An LE UV system requires less space, in particular in comparison both with conventional drying systems and with conventional UV systems.

In particular, the drying and/or the curing can be carried out without extended delivery. Further, for example, the space requirement for a control box, a cooler and an exhaust air unit is particularly small, in particular smaller than 2 m². Moreover, an ozone-free operation is possible through the use of special lamps.

Films, in particular films made of PET (PET=polyethylene terephthalate), which preferably have a UV permeability, are preferably used as carrier film of the transfer film. The photoinitiators of the first adhesion promoter here are preferably selected corresponding to the wavelengths for which the carrier film is permeable.

In particular it is expedient that the curing device and/or the precuring device comprises a cooling, in particular a water cooling, and/or is cooled, in particular is cooled by means of water. The curing device and/or the precuring device here preferably has one or more shutters and one or more reflectors, which are preferably cooled with water. Through the cooling of the shutters and the reflectors with water, in particular the heat developing is preferably dissipated from the machine directly and effectively.

It is alternatively or additionally possible for the curing device and/or the precuring device to comprise an integrated air cooling, which in particular ensures a uniform operation of the curing device and/or the precuring device. The integrated air cooling preferably ensures a uniform operation of the curing device and/or the precuring device, in particular the one or more radiation sources preferably in the form of a UV lamp.

It is moreover possible for the curing device and/or the precuring device to have electronic ballasts. An ELC control is preferably coupled to the irradiation power, with the result that the power, in particular the gross irradiance and/or the net irradiance, is continuously adjustable and/or adjusted, preferably within 30% to 100% of the maximum value. Here, the adjustment takes place for example depending on the printing speed and/or processing speed. In a standby operation the power, in particular the gross irradiance and/or the net irradiance, is preferably automatically brought down to a minimum.

Preferably, the curing is carried out in such a way and/or the curing device is formed in such a way that the power of the curing device, in particular the gross irradiance, lies in a range of from 160 W/cm² to 200 W/cm², preferably for mercury vapor lamps, and/or from 12 W/cm² to 20 W/cm², preferably for UV LED lamps. Preferably, the net irradiance lies in a range of from 4.8 W/cm² to 8 W/cm² and/or the energy input by the curing device into the first adhesion promoter lies in the range of from 200 mJ/cm² to 900 mJ/cm².

The curing of the first adhesion promoter is preferably effected with an exposure time of from 0.04 s to 0.15 s. At the mentioned processing speeds and/or transport speeds of the substrate and the specified irradiances, the necessary energy input is preferably ensured for the curing.

It is in particular possible for the one or more radiation sources to comprise a a radiation sources of the LAMPcure UV unit type.

A curing advantageously optimizes the tried and tested systems engineering with respect to power and energy conversion. It is possible here for the curing to be carried out by means of two individual plug-in units with a power of the curing device, in particular gross irradiance and/or net irradiance, of up to 200 W/cm². The advantage of a significant energy saving is achievable hereby.

Preferably, the precuring is carried out in such a way and/or the precuring device is formed in such a way that the power of the curing device, in particular the gross irradiance, lies in a range of from 2 W/cm² to 5 W/cm². The net irradiance preferably lies in a range of from 0.7 W/cm² to 2 W/cm² and/or the energy input by the precuring device into the first adhesion promoter preferably lies in a range of from 8 mJ/cm² to 112 mJ/cm². It is hereby achieved that the first adhesion promoter experiences in particular a desired viscosity increase, while preferably not being completely cured, with the result that, when the transfer ply is applied to the substrate, in particular the necessary adhesive action of the adhesion promoter is preserved.

The precuring of the first adhesion promoter is preferably effected with an exposure time of from 0.02 s to 0.056 s. At the mentioned processing speeds and/or transport speeds of the substrate and the specified irradiances, the necessary energy input for the precuring is preferably ensured.

It is expedient if, during the precuring of the first adhesion promoter, its viscosity increases to and/or by 200 mPa·s to 400 mPa·s. Such a viscosity increase guarantees in particular that the first adhesion promoter is not squeezed during the application of the transfer ply to the substrate, with the result that, after the peeling-off, the transfer ply preferably substantially remains on the substrate with the resolution achieved during the printing of the first adhesion promoter.

It is also possible for the transfer ply to be encompassed by a transfer film, wherein the transfer film preferably has the following layers, in particular in the specified order in cross section: a carrier film, an optional detachment layer, the transfer ply.

It is possible for the transfer ply to have one or more of the following layers, in particular in the specified order in cross section: a protective varnish layer on a side of the transfer ply facing the carrier film in the transfer film, a replication varnish layer, a colored varnish layer, a vaporizable varnish layer, a metal layer, in particular an aluminum layer, an adhesion-promoter layer, a barrier layer, a glue layer on a side of the transfer ply facing away from the carrier film in the transfer film. It is possible here for the transfer film to be a cold stamping film.

In particular, it is possible for the transfer film to be a first transfer film for use in a cold film transfer method, comprising a carrier film and a transfer ply detachable from the carrier film. In particular, the transfer ply here comprises, starting from the carrier film, a transparent detachment layer, an optional transparent protective varnish layer, at least one decorative layer and at least one primer layer made of a thermoplastic glue which is activatable in a temperature range above 90° C.

Here, the first transfer film has, in particular on its side facing away from the carrier film, a primer layer made of a thermoplastic glue which, during the application of the transfer ply to the substrate, in particular in the form of a cold film transfer, acts as adhesion-promoter layer for the first adhesion promoter, which is in particular an adhesion promoter that crosslinks under UV irradiation, on the substrate. Through a combination of a primer layer arranged on the transfer ply and made of thermoplastic glue with the first adhesion promoter arranged on the substrate, in particular the first adhesion promoter that crosslinks under UV irradiation, a particularly secure connection between the transfer ply and the substrate and/or the primer layer can advantageously be formed. This is in particular a surprising effect in this respect, as thermoplastic glues, preferably also called hot glues, and the first adhesion promoter, in particular the first adhesion promoter that crosslinks under UV irradiation, are substances the adhesive actions of which are based on entirely different physicochemical principles.

A first transfer film, as described above, for use in a cold film transfer method has a similar structure in particular to a hot-stamping film. In particular, the use of a transfer film in the form of a hot-stamping film, which has a carrier film and a transfer ply detachable from the carrier film, is ideal in a cold film transfer method, in which the transfer ply is fixed to a substrate by means of the first adhesion promoter, in particular in the form of a cold glue, which is preferably a glue that crosslinks under UV irradiation. As is known, hot-stamping films have a hot glue layer, which is heated during the hot-stamping process and—usually under additional application of pressure—in particular enters into an adhesive connection with the substrate to be stamped. After the cooling, the transfer ply is fixed to the substrate by means of the hot glue layer, with the result that the carrier film can preferably be peeled off.

Further, it is also possible for the transfer film to be a second transfer film for use in a cold film transfer method and to comprise a carrier film and a transfer ply detachable from the carrier film. In particular, the transfer ply here comprises, starting from the carrier film, a transparent polymeric detachment layer, an optional transparent protective varnish layer, at least one decorative layer and at least one primer layer.

In particular in the case of a transfer film, the force of detachment of the detachment layer from the carrier film and the force for removing regions from the transfer ply under transfer conditions, in particular during the peeling-off of the carrier film, is preferably formed smaller in total than the adhesive force between substrate and transfer ply, which is preferably influenced by the type of adhesion promoter used, in particular cold glue, and in particular its bond to the substrate on the one hand and to the primer layer on the other hand. Preferably, during the transfer, in particular during the peeling-off of the carrier film, the transfer ply or regions of the transfer ply is or are only then detached from the carrier film and remain adhering to the substrate, in particular adhering to the substrate in the first region. Before the transfer, in particular the peeling-off of the carrier film, the force of detachment of the detachment layer from the carrier film is preferably so high that a safe handling of the transfer film is guaranteed, preferably without the transfer ply detaching from the carrier film, for example during unwinding of the transfer film from a supply roll and/or during transport of the transfer film, possibly via deflection devices, for example into the second printing unit and in particular via the curing section and/or into a cold film transfer unit. In order to be able to wind and unwind the transfer film again, it has in particular proved worthwhile to provide a suitable nonstick layer on the side of the carrier film facing away from the transfer ply.

For each transfer film according to the invention it is particularly preferable if the detachment layer is formed free of wax and/or free of silicone. In particular, the transfer film does not have a conventional wax- or silicone-based detachment layer, which until now had the effect that transfer plies of transfer films which were equipped therewith could be printed on only to a limited extent or not at all with conventional printing inks, in particular UV-curing printing inks, UV-curing varnishes, hybrid inks or varnishes.

The use of a detachment layer based on an acrylate copolymer is particularly preferred for the first and/or second transfer film.

The detachment layer preferably has a thickness in the range of from 0.01 to 0.3 μm, preferably from 0.1 to 0.2 μm.

It has proved to be worthwhile if the at least one primer layer has a thickness in the range of from 1 μm to 5 μm, in particular in the range of from 1.5 μm to 3 μm.

Furthermore, the at least one primer layer can be formed dyed, and for example to strengthen a contrast relative to the substrate, etc.

Furthermore, it has proved to be worthwhile if the at least one primer layer, which is to adjoin the cold glue and/or the first adhesion promoter, has a surface roughness in the range of from 100 nm to 180 nm, in particular in the range of from 120 nm to 160 nm. The surface roughness is determined among other things by the method of deposition and the formulation of the primer layer. It has been established that a smaller surface roughness, surprisingly also, however, a greater surface roughness, of the primer layer leads to a reduction of the adhesion achievable between the first adhesion promoter, in particular in the form of a cold glue, and the transfer ply. The surface roughness of the primer layer was here determined in particular by means of an interference microscopy.

It is also possible for not only one primer layer to be present, but also two or more, which differ in terms of their chemical and/or physical properties, in order to achieve on one side an optimum adhesion in the direction of the adjoining decorative layer and/or the adjoining decorative layers and on the other side an optimum adhesion in the direction of the first adhesion promoter coming into contact with the transfer ply, in particular in the form of a cold glue, preferably UV glue.

In particular, it has proved to be worthwhile if each transfer film, optionally also only the transfer ply thereof, has a permeability for UV radiation in the wavelength range of from 250 nm to 400 nm, in particular in the range of from 310 nm to 410 nm, and/or in the range of from 365 nm to 405 nm, in the range of from 5% to 40%, in particular in the range of from 5% to 20%. By permeability is meant in particular the transmittance.

In particular, a particularly rapid and in particular complete full cure of the first adhesion promoter, preferably in the form of a cold glue, preferably based on a glue that crosslinks under UV irradiation, on the substrate thereby becomes possible, as a result of which the adhesion of the transfer ply to the substrate is improved still further. This is because, in particular only in the case of a sufficiently large amount of irradiation is the first adhesion promoter, in particular in the form of a glue that crosslinks under UV irradiation, completely crosslinked and full-cured and achieves a high adhesive force, with the result that a detachment of the transfer plies applied to the substrate in the first region with the first adhesion promoter from the substrate is reliably prevented. A determining factor for the UV permeability of a transfer film here is in particular the layer of a transfer film which has the lowest UV permeability of all layers present.

The carrier film preferably has a thickness in the range of from 4.5 μm to 23 μm. The carrier film is preferably formed of polyester, polyolefin, polyvinyl, polyimide or ABS. Here, the use of carrier films made of PET, PC, PP, PE, PVC or PS is particularly preferred. In particular, a carrier film made of PET has proved to be worthwhile.

Overall, the transfer film has in particular a thickness in the range of from 6 μm to 25 μm, in particular in the range of from 13 μm to 16 μm.

It has in particular proved worthwhile if the transfer ply has a protective varnish layer. The protective varnish layer provides in particular a protection against mechanical and/or chemical loading of the transfer ply on a substrate. The protective varnish layer preferably has a thickness in the range of from 0.8 μm to 3 μm, in particular from 0.9 μm to 1.3 μm, and can furthermore be colorless in a crystal clear manner or also dyed or at least partially dyed.

The at least one decorative layer of the transfer ply is preferably formed by at least one metallic layer and/or at least one dielectric layer. It has proved to be worthwhile if the at least one decorative layer preferably has a thickness in the range of from 8 nm to 1,500 nm. This layer has a large influence on the UV light transmission and thus on the full-cure behavior of the first adhesion promoter, in particular in the form of a UV glue.

In order, when the first adhesion promoter is used in the form of a UV glue, to achieve the desired high UV permeability of the transfer film also in the case of a decorative layer in the form of a metallic layer, it is particularly preferred if the metallic layer has only a layer thickness in the range of from 10 nm to 20 nm. Thus, a good visibility and decorative effect of the metallic layer in combination with a high permeability for UV radiation is achieved.

It has proved to be worthwhile if the metallic layer is preferably formed of aluminum, silver, gold, copper, nickel, chromium or an alloy comprising at least two of these metals. The dielectric layer is in particular formed at least of one material of the group comprising metal oxide, polymer or varnish. A dielectric layer of HRI material, such as SiOx, MgO, TiOx, Al₂O₃, ZnO, has proved to be particularly worthwhile. The variable x preferably lies in the range of from 0 to 3.

The decorative layer can in particular also be formed of an HRI material (HRI=High Refractive Index) which is permeable in the UV range, such as CdSe, CeTe, Ge, HfO₂, PbTe, Di, Te, TiCl or ZnTe.

It has proved worthwhile in particular if a decorative layer has a diffractive relief structure for generating optically variable effects and/or a macrostructure for generating three-dimensional effects or depth effects. Through diffractive relief structures, which are formed in particular in a transparent varnish layer, different optical effects, so-called optically variable effects, can be achieved depending on the angle of view, such as holograms, three-dimensional representations with kinematic effect dependent on the angle of view, etc.

It has proved to be particularly favorable in particular that a primer layer with a pigment count of from 1.5 cm³/g to 120 cm³/g is used, in particular the range of from 10 cm³/g to 20 cm³/g.

For the calculation, a preferred composition of the primer layer is indicated below (data in grams):

| | |
|---|---|
| 4900 | organic solvent ethyl alcohol |
| 150 | organic solvent toluene |
| 2400 | organic solvent acetone |
| 600 | organic solvent benzine 80/110 |
| 150 | water |
| 120 | binder I: ethyl methacrylate polymer |
| 250 | binder II: vinyl acetate homopolymer |
| 500 | binder III: vinyl acetate vinyl laurate copolymer, |
| | solid body = 50 +/− 1% |
| 400 | binder IV: isobutyl methacrylate |
| 20 | pigment multifunctional silicon oxide, average |
| | particle size 3 μm |
| 5 | filler micronized amide wax, particle size 3 |
| | μm to 8 μm |

The following is true for the pigment count for this primer layer:

$$PC = {\sum }_{1}^{X} \frac{{( {m}_{p} \times f )}_{x}}{{m}_{BM} + {m}_{A}} = \frac{20 g \times 750}{1020 g + 0 g} = 14.7 {cm}^{3} / g \\ where :$$

$$mp = 20 g multifunctional silicon oxide$$

$$f = OAV / d = 300 / 0.4 g / {cm}^{3} = 750 {cm}^{3} / g for multifunctional silicon oxide$$

$${m}_{BM} = 120 g binder I + 250 g binder II + ( 0.5 \times 500 g ) binder III + 400 g binder IV = 1020 g$$

$${m}_{A} = 0 g .$$

In this way, starting from a composition of the primer layer found to be good, in particular, further possible pigmentations deviating therefrom can preferably be calculated quickly and in an uncomplicated manner.

In particular, the first adhesion promoter comprises UV inks. UV inks here consist in particular, in addition to a high proportion of binder, of color pigments and/or dyes and/or additives and photoinitiators. UV inks preferably dry in a photochemical process, wherein a curing, in particular full cure, or a precuring of the binders contained is triggered by photoinitiators under the action of UV radiation. In particular, a UV ink is already almost completely fixed immediately after the first inking unit and/or immediately after the transfer of the first adhesion promoter to the substrate and one run through the UV radiation of an emitter.

The UV inks comprise in particular UV-curing systems. UV-curing systems comprise in particular reactive acrylates, epoxides, enol ethers and/or cyclic amines. Further, UV-curing systems comprise for example aziridine as binder. It is also conceivable that the UV-curing systems comprise unsaturated polyester resins. In addition, it is possible for the UV-curing systems to contain photoinitiators and aids, such as for example crosslinkers, leveling agents, thickening agents, dispersing additives, matting agents, antioxidants and/or pigments, preferably organic colored pigments, carbon black and/or titanium dioxide. During exposure to light, photoinitiators preferably form radicals and/or reactive cations, in particular superacids, and induce a polymerization or crosslinking reaction of longer-chain molecules. Radically curing systems are particularly preferably used. It is thus possible for the first adhesion promoter to comprise a radically curing UV glue.

The first adhesion promoter is preferably a cold glue. In particular, a glue that crosslinks under UV irradiation, in particular a flexographic glue, with the following composition (in weight %) is used as cold glue:

| | |
|---|---|
| 45-50 | glycol diacrylate(s) |
| 20-25 | polyester/urethane acrylate(s) |
| 20-25 | polyester acrylate(s) |
| 5-10 | adhesion promoter(s) |
| 3-8 | photoinitiator(s) |
| 0-5 | monomer acrylate(s). |

The first adhesion promoter further preferably comprises or consists of one or more of the following materials: printing ink, in particular flexographic printing ink, curing component, adhesive, in particular UV adhesive, preferably in the form of a radically curing UV adhesive.

Depending on the choice of the curing component, which are in particular curable by means of an irradiation selected from: UV irradiation, in particular by means of high pressure UV mercury vapor lamps, medium pressure UV mercury vapor lamps, low pressure UV mercury vapor lamps, low energy UV and/or UV LED emitters, and/or electron beam radiation sources, the underlying photoinitiator is preferably matched. Here, an adhesion promoter comprising a UV LED curing component can in particular be cured with all systems, in particular all of the named systems. An adhesion promoter comprising a standard UV curing component can, on the other hand, only be cured with a standard UV lamp, in particular in high pressure and/or low pressure.

It is also possible for the first printing unit to have a first inking unit that can be coupled and decoupled and comprises at least one first inking roller and a first plate cylinder and/or for the second printing unit to have a second inking unit that can be coupled and decoupled and comprises at least one second inking roller and a second plate cylinder. Further, it is conceivable that the first printing unit has a first dampening unit that can be coupled and decoupled and comprises at least one first dampening roller and/or that the second printing unit has a second dampening unit that can be coupled and decoupled and comprises at least one second dampening roller.

The first inking unit is preferably formed, in a coupled state of the first inking unit, in such a way that the first inking unit transfers a second adhesion promoter to the transfer medium, in particular in such a way that the second adhesion promoter is transferred with the first adhesion promoter from the transfer medium to the substrate. By means of the first inking unit, in a coupled state of the first inking unit, a second adhesion promoter is thus preferably transferred to the transfer medium, in particular in such a way that the second adhesion promoter is transferred with the first adhesion promoter from the transfer medium to the substrate.

Here, the second adhesion promoter is preferably transferred to the transfer medium and/or the substrate in a second region, which preferably partially overlaps and/or does not overlap the first region. In particular, it is also possible here for the second adhesion promoter then to be precured by means of the precuring device and/or to be cured by means of the curing device.

An advantage is in particular achieved in that, depending on the requirements of a product to be produced, the printing device is flexibly settable. For example, the second adhesion promoter can be used when a more absorbent substrate is used and/or the first adhesion promoter can be used in the case of a higher desired gloss of the transfer film.

Further, for example, the advantage is achieved that, because of the above-described effects of the flow and deformation properties of an adhesion promoter on the gloss, various gloss effects, in particular with particularly large gloss differences, can be generated in various regions of the applied transfer ply. In particular, the second adhesion promoter here is an offset cold film glue and/or has non-Newtonian or almost non-Newtonian behavior. As a result, for example, a particularly appealing optical appearance is generated and/or the protection against forgery is increased.

It is also conceivable that a printing ink, in particular offset printing ink, is transferred to the substrate by means of the first and/or second inking unit.

Here, it is possible in particular for a printing ink, in particular offset printing ink, to be transferred to the transfer medium and/or to a printing blanket arranged on the transfer cylinder by means of the first inking unit and to be transferred to the substrate with or without the first adhesion promoter.

It is thus conceivable that, by means of the first printing unit, the first adhesion promoter in the form of a flexographic printing glue and/or a flexographic printing ink and the second adhesion promoter in the form of an offset printing glue and/or an offset printing ink is transferred to the substrate.

By means of the second inking unit, in particular the second printing plate, a printing ink, in particular offset printing ink, is preferably transferred to a printing blanket arranged on the pressing cylinder, wherein it is also conceivable that the transfer ply here is preferably not applied to the substrate by means of the second printing unit.

In particular, it has proved to be advantageous that one or more of the following steps are carried out, in particular are carried out one or more times in any order:
coupling or decoupling the first inking unit and/or the first dampening unit,
coupling or decoupling the second inking unit and/or the second dampening unit,
coupling or decoupling the anilox roller, in particular together with the chamber doctor blade system, and/or the chamber doctor blade system.

A coupling and/or decoupling is possible in particular in the form of taking out, displacing and/or turning.

Preferably, the first inking unit, the first dampening unit, the second inking unit, the second dampening unit, the anilox roller and/or the chamber doctor blade system is inoperable in a decoupled state.

In the coupled state of the first and/or second inking unit, the first and/or second plate cylinder preferably has a printing plate which has hydrophilic regions which are provided with water by means of the first and/or second dampening unit, in such a way that the hydrophilic regions do not take up a second adhesion promoter and/or an offset ink and/or do not transfer them to the transfer medium. In particular, a partial, preferably patterned, transfer of the second adhesion promoter and/or the offset ink from the printing plate to the transfer medium is carried out thereby.

Here, in particular, the advantage now arises that a printing machine can be used multifunctionally preferably once with cold stamping and/or cold film transfer and once without cold stamping and/or cold film transfer.

In particular, depending on the desired gloss level of the transfer ply or different regions of the transfer ply, the first and/or the second adhesion promoter and/or a printing ink can thus advantageously be printed.

Further, for example, the resource efficiency of a printing device, in particular offset printing device, is hereby increased, because the transfer cylinder takes on a dual function.

A substrate that has been finally covered with transfer ply partially or over the whole surface and optionally further processed and/or printed on is preferably used in the form of wet glue labels, in-mold labels, magazines or as packaging material, such as for example folding boxes, and the like. In other words, for example, wet glue labels, in-mold labels, magazines or as packaging material, such as for example folding boxes, and the like are produced by means of the printing device and/or by means of the method.

Further, a use of a first transfer unit comprising a transfer cylinder with a transfer medium in a printing device, in particular offset printing device, is expedient, which is characterized in that an offset blanket and/or offset blanket cylinder in the printing device, in particular offset printing device, was removed beforehand, in particular was removed in such a way that the transfer unit comprising the transfer cylinder with the transfer medium replaces the offset blanket and/or the offset blanket cylinder.

Further, a method for converting a printing device, in particular offset printing device, is conceivable which is characterized in that the method comprises the following steps, which are carried out in particular in the following order:
providing a printing device, in particular offset printing device,
optionally replacing an offset blanket cylinder of the printing device with a transfer cylinder
replacing an offset blanket with a transfer medium
optionally coupling or decoupling a first inking unit comprising at least one first inking roller and a first plate cylinder and/or a first dampening unit comprising at least one first dampening roller,
optionally arranging a curing device for curing the first adhesion promoter in such a way that the curing device is arranged, in particular in the conveying direction of the substrate, before a peeling-off device and/or after the first transfer unit.

### BRIEF DESCRIPTION OF THE DRAWINGS

In the following, the invention is explained by way of example with reference to several embodiment examples with the aid of the attached drawings. There are shown in:

FIG. 1 schematically shows a printing device and a method,

FIGS. 2a and 2b schematically show a transfer cylinder and a transfer medium,

FIGS. 3a and 3b schematically show a substrate in a printing device and a method,

FIG. 4 schematically shows a printing unit,

FIG. 5 schematically shows a transfer unit,

FIGS. 6a to 6c schematically show an anilox roller,

FIG. 7 schematically shows a printing unit,

FIG. 8 schematically shows a printing device,

FIG. 9 schematically shows a printing unit,

FIGS. 10 and 11a and 11b schematically show a printing unit,

FIGS. 12 to 14 schematically show a printing device and a method,

FIGS. 15a and 15b schematically show an inking unit and a dampening unit,

FIGS. 16 and 17 schematically show a transfer film.

### DETAILED DESCRIPTION

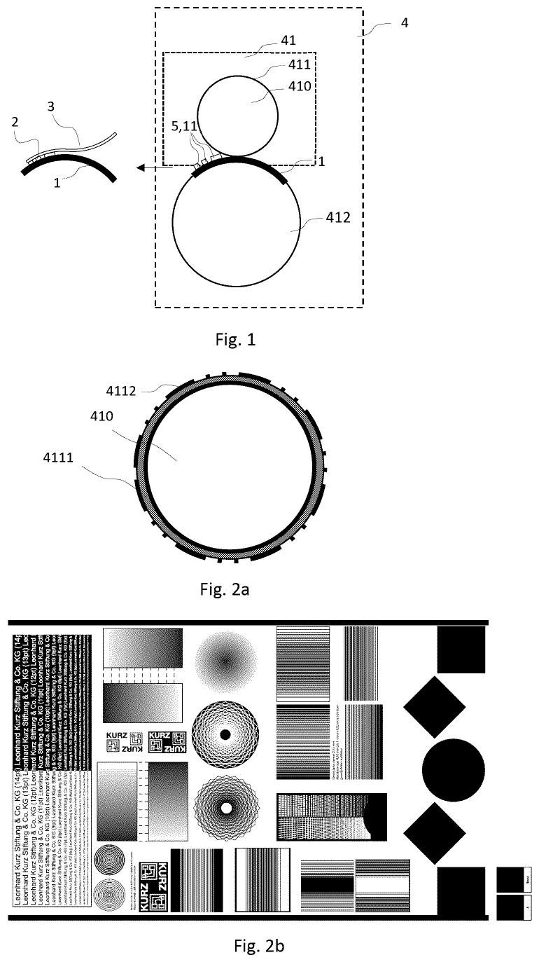

FIG. 1 schematically shows a printing device, which is in particular an offset printing device, for transferring the transfer ply 2 of the transfer film 3 to the substrate 1.

The printing device has the first printing unit 4, which has the first transfer unit 41 comprising the transfer cylinder 410 with the transfer medium 411. Further, the first printing unit 4 has the first substrate cylinder 412. The first transfer unit 41 of the first printing unit 4 here is designed in such a way that the first adhesion promoter 5 is transferred from the transfer medium 411 to the first region 11 of the surface of the substrate 1.

FIG. 1 further shows the method for transferring the transfer ply 2 of the transfer film 3 to the substrate 1, by means of the printing device represented, which is in particular an offset printing device.

The method comprises the following step and optionally further steps:
transferring the first adhesion promoter 5 by means of the first printing unit 4, which has the first transfer unit 41 comprising the transfer cylinder 410 with the transfer medium 411.

Further, the first printing unit 4 has the first substrate cylinder 412. The first adhesion promoter 5 here is transferred from the transfer medium 411 to the first region 11 of the surface of the substrate 1.

The substrate 1 here is preferably fed through a gap between the transfer cylinder 410 with the transfer medium 411 and the first substrate cylinder 412 in such a way that the first adhesion promoter 5 is transferred to the substrate 1.

The transfer of the first adhesion promoter 5 to the substrate 1 is preferably carried out with a contact pressure, wherein the contact pressure is settable and/or is set preferably via the spacing, in particular in the form of a gap, of the transfer medium 411 and/or the transfer cylinder 410 with the transfer medium 411 and the first substrate cylinder 412. Here, this spacing is in particular 0.00 mm. It is in particular also possible for this spacing to lie in the range of from −0.5 mm to +0.75 mm, preferably in the range of from −0.1 mm to +0.3 mm and/or to be able to be set in this range. These negative and positive values relate in particular to a basic setting of the first substrate cylinder 412 relative to the transfer cylinder 410, and in particular relative to the surface of the transfer medium 411, preferably also taking the layer size and/or layer thickness of the substrate 1 into account. From this basic setting, the pressure on the substrate 1 can now be reduced, in particular by setting negative values, for example −0.1 mm, and/or be increased, in particular by setting positive values, e.g. +0.3 mm.

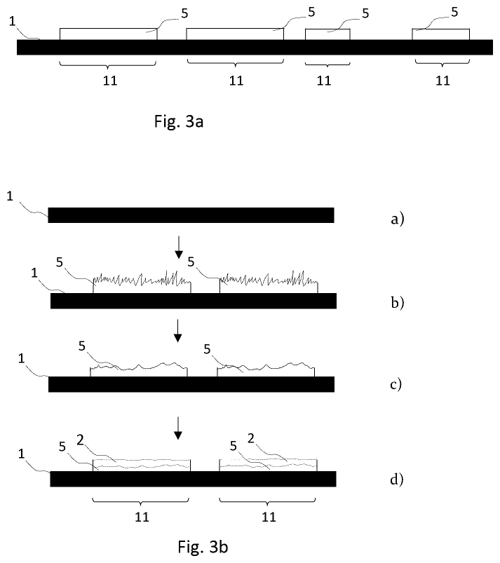

FIG. 2a shows the transfer cylinder 410 with the transfer medium 411, which preferably has or consists of the carrier plate 4111 and the outer layer 4112, which is arranged in particular on the side of the carrier plate 4111 facing away from the transfer cylinder 410.

FIG. 2b shows the outer layer 4112 in a top view, wherein the transfer medium 411 is preferably not stretched over the transfer cylinder 410, or a schematic unwinding of the outer layer 4112.

The regions depicted black here preferably show raised regions, which form one or more motifs.

The lines of the transfer medium 411 here have in particular a line thickness of between 0.1 mm and 0.5 mm. The positive type and the negative type are legible up to a type size of 5 pt, in particular if the type is formed by the transfer ply 2 after the carrier film 31 has been peeled off of the transfer ply 2. Here, for example, one motif of the several motifs shown has a grid width of 42 lines/cm. Further, with the transfer medium 411 it is preferably possible for the first adhesion promoter 5 to be transferred to the substrate with a tonal value in the range of from 35% to 75%.

The transfer medium 411 here has, for example, a thickness in the range of from 0.5 mm to 10 mm, in particular in the range of from 0.76 mm to 6.35 mm, and/or a length in the range of from 500 mm to 2,000 mm and/or a width in the range of from 500 mm to 1,500 mm. Here, the thickness at the position at which the maximum thickness of the total of the thickness of the carrier plate 4111 and preferably the thickness of the outer layer 4112 is located is preferably indicated.

Further, it is possible for the transfer medium 411 to comprise the carrier plate 4111, which in particular comprises or consists of polyester, preferably PET (polyethylene terephthalate), and/or metal, preferably aluminum. The carrier plate 4111 preferably has a thickness in the range of from 1.0 mm to 2.0 mm, in particular in the range of from 1.0 mm to 1.5 mm, for example a thickness of 1.16 mm. It is also conceivable that the total of the layer thickness of the carrier plate 4111 and the outer layer 4112 preferably lies in the above range.

The transfer medium 411, in particular the outer layer 4112 of the transfer medium 411, preferably comprises one or more motifs. The one or more motifs are preferably introduced into the transfer medium 411, in particular the outer layer 4112 of the transfer medium 411, photochemically, in particular by means of exposure to light and etching, and/or by means of milling, engraving and/or laser machining.

The transfer medium 411 and/or the outer layer 4112 of the transfer medium 411 here is preferably a varnish plate from Dupont Cyrel of the EASY FAST EFM 45 type. The outer layer here has, for example, a thickness of 1.14 mm.

It is thus possible for the first adhesion promoter 5 to be transferred to the substrate 1 in the first region 11 over the whole surface and/or partially, in particular in the form of one or more patterns and/or motifs, by means of the transfer medium 411.

The transfer medium 411 preferably has the outer layer 4112, which preferably comprises or consists of a photopolymer. Preferably, the transfer medium 411, in particular the outer layer 4112 of the transfer medium 411 comprising a photopolymer, has been or is exposed to light and full-cured, preferably exposed to light and full-cured patterned, by means of a mask, in particular a black mask.

Excess polymer is then preferably removed, for example washed out or removed as powder. In particular, one or more motifs, for example a positive motif which is applied to the carrier plate 4111 relief-like, remain behind.

The transfer medium 411 is thus used for example for inline and/or offline print finishing with dispersion varnishes, but for example also for UV varnishes. The adhesion promoter 5, in particular in the form of a UV flexographic glue, an aqueous flexographic glue or a solvent-based flexographic glue, is preferably transferred to the substrate 1 by means of such a transfer medium 411.

It has proved to be advantageous that the first adhesion promoter 5 is transferred from the transfer medium 411, in particular from the outer layer 4112, to the substrate 1 at least in regions with a resolution of at most 150 lpi, in particular of at most 120 lpi, and/or of at most 59 lines/cm, preferably of at most 47 lines/cm.

The advantage is hereby achieved in particular that the principle-based maximum resolution for transferring the transfer ply to the substrate can be achieved by means of the transfer medium, wherein the maximum possible gloss of the transfer ply is in particular increased after the transfer.

For this, it is expedient that the transfer medium 411, in particular the outer layer 4112 of the transfer medium 411, preferably at least one first motif of the one or more motifs, has a grid width of at most 150 lpi, in particular of at most 120 lpi, and/or of at most 59 lines/cm, preferably of at most 47 lines/cm. It is also possible for the transfer medium 411, in particular the outer layer 4112 of the transfer medium 411, preferably at least one second motif of the one or more motifs, to have a grid width of at most 150 lpi, in particular of at most 120 lpi, and/or of at most 59 lines/cm, in particular of at most 47 lines/cm.

It is possible here for the one or more motifs of the transfer medium 411, in particular the outer layer 4112 of the transfer medium 411, to comprise one or more lines with a line thickness in the range of from 0.05 mm to 0.9 mm, in particular in the range of from 0.1 mm to 0.15 mm.

For example, the transfer medium 411, in particular at least one motif of the one or more motifs, here has a thinnest standalone line of 0.15 mm and/or of 6 mil and in particular a smallest standalone dot of 0.15 mm and/or of 150 microns.

Further, the transfer medium, in particular at least one motif of the one or more motifs, here has for example a relief depth of 0.55 mm.

Further, it is possible for the transfer medium 411, in particular the outer layer 4112 of the transfer medium 411, to have a hardness in the range of from 50 Shore A to 80 Shore A, in particular from 55 Shore A to 60 Shore A. For example, the transfer medium here has a hardness of 73 Shore A.

In particular, it is possible for the transfer medium 411, in particular the outer layer 4112 of the transfer medium 411, preferably the one or more motifs, to have a surface roughness, preferably an Ra value, in the range of from 0.05 μm to 1 μm, in particular in the range of from 0.2 μm to 0.8 μm.

The surface of the transfer medium 411, in particular the outer layer 4112, preferably the one or more motifs, is thus advantageously smooth enough to guarantee a very good transfer of the first adhesion promoter, in particular wherein only a small dot gain takes place.

Further, in particular, the wettability of the transfer medium 411 with the first adhesion promoter is hereby improved. For example, a back splitting of the adhesion promoter 5 can be prevented for the most part or completely. Further, it is hereby preferably guaranteed that the adhesion promoter 5 does not run or drip in an uncontrolled manner on the transfer medium 411, and pick forces acting on the substrate which are too strong are preferably prevented.

As the transfer medium 411, at least one from the following table is preferably used, wherein the thinnest standalone line preferably has a width of 0.15 mm and/or the smallest standalone dot has a diameter of 0.15 mm.

| | | | | |
|---|---|---|---|---|
| Thickness in mm | 1.14 | 1.70 | 2.54 | 2.84 |
| Shore A hardness | 73 | 65 | 56 | 55 |
| Tonal value in % | 1 to 98 | 1 to 98 | 1 to 98 | 1 to 98 |
| Grid width in lines/cm | 75 | 75 | 54 | 54 |
| Relief depth in mm | 0.55 | 0.65 | 0.80 | 0.90 |

The first transfer unit 41 comprising the transfer cylinder 410 with the transfer medium 411 is preferably used in a printing device, in particular used in an offset printing device.

The advantage is thus achieved in particular that the range of the materials that can be printed by means of this printing device, in particular this offset printing device, is increased and preferably conversion times are reduced.

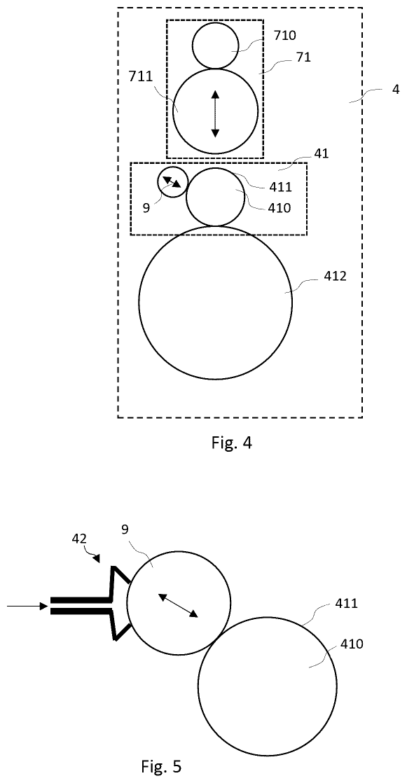

FIG. 3a schematically shows a substrate 1 with the adhesion promoter 5 applied thereto in the first region 11.

Here, it is preferably also conceivable that in partial regions a second adhesion promoter is applied instead of the first adhesion promoter 5.

FIG. 3b schematically shows a substrate 1 with first adhesion promoter 5 transferred in the first region 11, as is also outlined for example in FIG. 1.

FIG. 3b schematically illustrates the substrate 1 in the printing device, in particular offset printing device, shown in FIG. 1 for transferring the transfer ply 2 of the transfer film 3 to the substrate 1, which transfers the first adhesion promoter 5 to the substrate 1. Further, the transfer of the first adhesion promoter 5 to the substrate 1, which is illustrated in particular with the upper arrow, in the method for transferring the transfer ply 2 of the transfer film 3 to the substrate 1 is shown. In addition, an optional running of the surface of the transferred adhesion promoter 5 is shown schematically with the middle arrow. By means of the arrows, transitions between the schematically represented states a), b), c) and/or d) are shown in particular.

State a) shows the substrate in particular before the first adhesion promoter 5 is applied to the substrate 1 and/or to the first substrate cylinder 412 in the conveying direction of the substrate 1 before the gap between the transfer cylinder 410, in particular with the transfer medium 411, and the first substrate cylinder 412.

State b) shows in particular the surface of the first adhesion promoter 5 with a degree of surface roughness, which is only schematically shown very rough here.

State c) preferably shows schematically the surface finish of the first adhesion promoter 5 after it has run in an advantageous manner in particular owing to its flow properties and deformation properties.

The lower arrow shows in particular the application of the transfer ply 2 of the transfer film 3 to the substrate. State d) shows the substrate 1 with the first adhesion promoter 5 and the transfer ply 2 subsequently applied to the first adhesion promoter 5, the surface finish of which depends in particular on the surface finish of the adhesion promoter 5 and its flow properties and deformation properties and the surface finish of which here is advantageously particularly smooth and/or glossy.

In particular, a not depicted lateral running of the first adhesion promoter 5 is also conceivable here, which is controlled by means of the precuring and/or the precuring device.

It is particularly preferably possible for the method to be carried out in such a way and/or for the printing device, in particular offset printing device, to be formed in such a way that the transfer ply 2, in particular measured after the carrier film 31 of the transfer film 3 has been peeled off, has a smoothness, in particular measured according to Bekk in accordance with DIN 53107:2016-05, preferably with a Bekk Smoothness Tester, preferably of the type 533 from Messmer Büchel, of at least 200 s and/or has a surface smoothness, in particular measured according to the Parker Print Surf (PPS) method, preferably using the air leak method according to DIN ISO 8791-4:2008-05, preferably by means of a Parker Print Surf PPS 90 tester from Messmer Büchel, in the range of from 0.05 μm to 1.5 μm, preferably in the range of from 0.1 μm to 1 μm.

Further, it is possible for the method to be carried out in such a way and/or for the printing device, in particular the offset printing device, to be formed in such a way that the transfer ply 2, in particular measured after the carrier film 31 of the transfer film 3 has been peeled off, has a gloss, in particular, greater than 500 GU with a measurement geometry of 60° and/or greater than 100 GU with a measurement geometry of 85°, preferably measured with a device of the type “micro tri gloss” from Byk Gardner. These measurement devices serve in particular to determine the gloss level, preferably of varnish coatings, plastics, ceramic and/or metallic surfaces. The surface is in particular spotlighted at a defined angle and the reflected light is preferably measured photoelectrically, preferably by means of a reflectometer. The measurement device corresponds in particular to the standards DIN 67530, ISO 2813, ASTM D 523 and/or BS 3900 Part D5. In particular with the “micro tri gloss” device, the gloss is preferably determined in gloss units or reflectance.

The gloss, the smoothness and/or the surface smoothness of the transfer ply 2 and/or of the substrate 1 with the transfer ply 2 is preferably measured in the first region 11, in particular measured on the surface of the transfer ply 2 in the first region 11.

With respect to the testers, testing devices, measurement devices and/or measurement methods, reference is made in particular to the above statements.

It is expedient here that only a small amount of back splitting or substantially no back splitting takes place during the transfer of the first adhesion promoter 5 from the transfer medium 411 to the substrate 1. For example, it is also possible for small quantities of the adhesion promoter 5 to remain on the transfer medium 411 during the transfer thereof to the substrate 1. However, the quantity is in particular kept small. A small amount of back splitting has, as described above, the advantage in particular that the surface of the first adhesion promoter 5, directly after the transfer, is already relatively smooth.

Further, it is expedient that the first adhesion promoter 5 has a Newtonian behavior or an almost Newtonian behavior, in particular measured in a state before the first adhesion promoter 5 is delivered to the first transfer unit 41 and/or while the first adhesion promoter 5 is being transferred to the substrate 1. In particular, the previously described running is hereby possible. In particular, a non-Newtonian or almost non-Newtonian behavior in contrast would not allow any or would only allow a slight running.

The viscosity, in particular the dynamic viscosity, of the first adhesion promoter 5 preferably deviates from a constant viscosity, in particular a constant dynamic viscosity, and/or a Newtonian behavior, at most with a tolerance in the range of from 50 mPa·s to 250 mPa·s, preferably in the range of from 50 mPa·s to 200 mPa·s, preferably in the range of from 50 mPa·s to 150 mPa·s, wherein the constant viscosity, in particular the constant dynamic viscosity, is preferably an average value around which the tolerance values vary.

It is expedient that the first adhesion promoter 5 has a viscosity, preferably a dynamic viscosity, in the range of from 200 mPa·s to 5,000 mPa·s, preferably in the range of from 500 mPa's to 1,500 mPa·s, in particular measured in a state before the first adhesion promoter 5 is delivered to the first transfer unit 41 and/or while the first adhesion promoter 5 is being transferred to the substrate 1. In the case of the viscosity, in particular dynamic viscosity, indicated in the above range it can in particular also be an average value around which in particular the tolerance values vary.

Newtonian behavior or almost Newtonian behavior and such a viscosity thus have the advantage in particular that the surface roughness of the first adhesion promoter 5 can be reduced further after the transfer to the substrate 1 due to the flowability of the first adhesion promoter 5.

The tackiness of the first adhesion promoter 5 is preferably improved. A viscosity, as described above, of the first adhesion promoter 5 contributes in particular to such a tackiness. The measurement of the tackiness here is carried out in particular as described above.

It is expedient in particular that the first adhesion promoter 5 is transferred to the substrate 1 with a deposition volume in the range of from 2 cm³/m² to 10 cm³/m², preferably in the range of from 2.5 cm³/m² to 7 cm³/m², and/or with a deposition weight of from 3 g/m² to 15 g/m², preferably in the range of from 4 g/m² to 8 g/m².

The adhesion promoter 5 is for example a glue of the WF UV 31 LMI type from LEONHARD KURZ Stiftung & Co. KG and/or with the following composition:

| | |
|---|---|
| Propylidynetrimethanol, ethoxylated, esters with acrylic acid | 30-60% |
| Chlorinated polyester acrylate | 10-20% |
| Acrylated resin | 5-20% |
| 1,1,1-Trihydroxymethylpropyl triacrylate | 10-20% |
| 1-Butanone, 2-(dimethylamino)-2-((4-methylphenyl)methyl)- | <5% |
| 1-(4-(4-morpholinyl)phenyl) | |
| Pentaerythritol triacrylate and Pentaerythritol tetraacrylate | <2.5% |
| reaction product | |
| Glyceryl propoxy triacrylate | <2.55 |
| Polyol acrylate | <1% |
| 2,6-Di-tert.-butyl-4-methylphenol | <0.25% |
| Hydroquinone | <0.25% |

The substrate 1 advantageously has, in particular measured before the transfer of the first adhesion promoter 5 to the substrate 1, a surface smoothness, preferably measured according to PPS 10, ISO 8791-4, in the range of from 0.5 μm to 2.0 μm, preferably with a tolerance in the range of from 0.01 μm to 0.2 μm. It is also possible for the substrate 1 to have a gloss in the range of from 20% to 80%, preferably in the range of from 50% to 75%, in particular measured according to TAPPI® T480, preferably with the measurement device microgloss 75° from BYK Gardner, preferably at an angle of 75°.

Further, it is expedient that the substrate 1 has a pick resistance, in particular measured before the transfer of the first adhesion promoter 5 to the substrate 1, preferably measured according to ISO 3783:2006-07, preferably with the measurement device Amsterdam 5 (4 m/s) from IGT, of from 0.5 m/s to 4 m/s, in particular from 0.75 m/s to 4 m/s.

It has proved to be advantageous in particular that the substrate 1, in particular measured before the transfer of the first adhesion promoter 5 to the substrate 1, has a penetration behavior in the range of from 0.9 OD to 1.3 OD (OD=Optical Density). The penetration behavior is measured in particular on a test printing device from IGT.

With respect to the testing devices and/or measurement methods for the gloss, the surface smoothness, the penetration behavior and/or the pick resistance of the substrate 1, reference is made in particular to the above statements.

The substrate 1 preferably has a surface that has been coated at least twice and is as smooth as possible, and it is preferably not very absorbent. Further, the substrate 1 preferably has a grammage, in particular a specific weight, of between 70 g/m² and 350 g/m².

Further, it is possible for the substrate 1 to be a substrate of the Ensocoat 2S, Invercote G or Performa White type, in particular from Stora Enso and/or Iggesund Paperboard.

It is possible in particular for substrate to be processed in sheets, wherein four examples are named below.

In a first example, 10,000 sheets are processed per hour. This preferably corresponds to approx. 7,200 m per hour and/or 120 m per minute. Between the transfer of the first adhesion promoter 5 and the application of the transfer ply 2 to the substrate 1 with the adhesion promoter 5 transferred in the first region 11, the substrate 1 with the adhesion promoter 5 is conveyed over a section in the range of from 1 m to 1.2 m and/or in a period of from 0.5 s to 0.6 s. A conveying from the application of the transfer ply 2 to the substrate 1 with the adhesion promoter 5 transferred in the first region 11 to the curing and/or the curing device is preferably carried out here over a section of 0.2 m and/or lasts 0.1 s.

In a second example, 8,000 sheets are processed per hour. This preferably corresponds to approx. 5,760 m per hour and/or 96 m per minute. Between the transfer of the first adhesion promoter 5 and the application of the transfer ply 3 to the substrate 1 with the adhesion promoter 5 transferred in the first region 11, the substrate 1 with the adhesion promoter 5 is conveyed over a section in the range of from 1 m to 1.2 m and/or in a period of from 0.62 s to 0.75 s. A conveying from the application of the transfer ply 2 to the substrate 1 with the adhesion promoter 5 transferred in the first region 11 to the curing and/or the curing device is preferably carried out here over a section of 0.2 m and/or lasts 0.125 s.

In a third example, 12,000 sheets are processed per hour. This preferably corresponds to approx. 8,640 m per hour and/or 144 m per minute. Between the transfer of the first adhesion promoter 5 and the application of the transfer ply 2 to the substrate 1 with the adhesion promoter 5 transferred in the first region 11, the substrate 1 with the adhesion promoter 5 is conveyed over a section in the range of from 1 m to 1.2 m and/or in a period of from 0.42 s to 0.5 s. A conveying from the application of the transfer ply 2 to the substrate 1 with the adhesion promoter 5 transferred in the first region 11 to the curing and/or the curing device is preferably carried out here over a section of 0.2 m and/or lasts 0.083 s.

In a fourth example, 20,000 sheets are processed per hour. This preferably corresponds to approx. 14,400 m per hour and/or 240 m per minute. Between the transfer of the first adhesion promoter 5 and the application of the transfer ply 2 to the substrate 1 with the adhesion promoter 5 transferred in the first region 11, the substrate 1 with the adhesion promoter 5 is conveyed over a section in the range of from 1 m to 1.2 m and/or in a period of from 0.25 s to 0.3 s. A conveying from the application of the transfer ply 2 to the substrate 1 with the adhesion promoter 5 transferred in the first region 11 to the curing and/or the curing device is preferably carried out here over a section of 0.2 m and/or lasts 0.05 s.

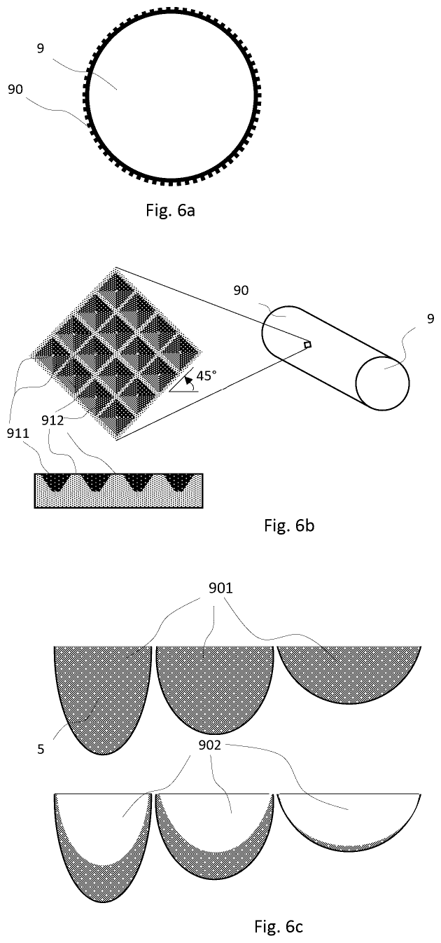

FIG. 4 shows the first printing unit 4 described in FIG. 1, and in particular with the transfer cylinder 410 described in FIG. 2a and FIG. 2b with the transfer medium 411, except that the first transfer unit 41 further comprises the anilox roller 9.

The anilox roller 9 is preferably formed in such a way that it transfers the first adhesion promoter 5 to the transfer medium 411 of the first transfer unit 41.

In particular, the anilox roller 9 can be coupled and decoupled, which is represented here by the double arrow. At least the anilox roller 9 is preferably formed displaceable and/or rotatable and/or removable. The first adhesion promoter 5 is transferred to the transfer medium 411 of the first transfer unit 41 by means of the anilox roller 9, in particular wherein the anilox roller 9 can be coupled and decoupled.

Further, the first printing unit 4 depicted in FIG. 4 here optionally comprises the first inking unit 71, which has at least the first inking roller 710 and the first plate cylinder 711. The first inking unit 71 here can preferably be coupled and decoupled, which is represented here by the double arrow. At least the first plate cylinder 711 and/or the first inking unit 71 is preferably formed displaceable and/or rotatable and/or removable.

By “can be coupled and decoupled” is meant here in particular that a connection to the transfer medium 411 and/or the transfer cylinder 410, which makes a transfer of an adhesion promoter, in particular the first and/or second adhesion promoter, and/or a printing ink, from the component that can be coupled and decoupled to the transfer medium 411 possible, can be produced and removed. This preferably also applies in the case of a first inking unit 71 and/or dampening unit that can be coupled and decoupled.

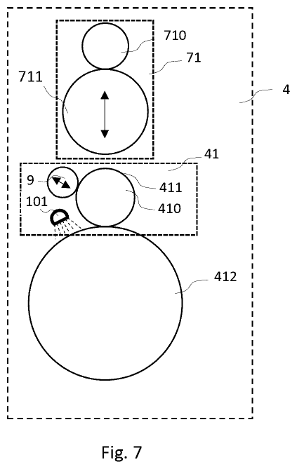

FIG. 5 shows in particular the first transfer unit 41 described in FIG. 4, wherein a chamber doctor blade system 42 is further arranged on the anilox roller 9.

It is thus possible for the first transfer unit 4 further to comprise a chamber doctor blade system 42 which is formed in such a way that the first adhesion promoter 5 is transferred from the chamber doctor blade system 42 to the anilox roller 9. In particular, the chamber doctor blade system 42 here can preferably be coupled and decoupled together with the anilox roller 9.

Here, it is possible for the chamber doctor blade system 42 to comprise a reservoir, not represented in more detail here, for the first adhesion promoter 5 and a delivery system, not represented in more detail here, for the first adhesion promoter 5. The chamber doctor blade system 42 preferably transfers the first adhesion promoter 5 from a chamber to the anilox roller 9 and scrapes the first adhesion promoter 5 off by means of doctor blades. A negative pressure, which advantageously prevents a foaming of the first adhesion promoter, preferably prevails in the chamber doctor blade system 42.

Instead of a chamber doctor blade system 42, a dip tank system, preferably with a tank and a dip roller, is also conceivable, wherein the first adhesion promoter 5 is transferred from the tank via the dip roller to the anilox roller 9 and is preferably scraped off the anilox roller 9 by means of one or more doctor blades.

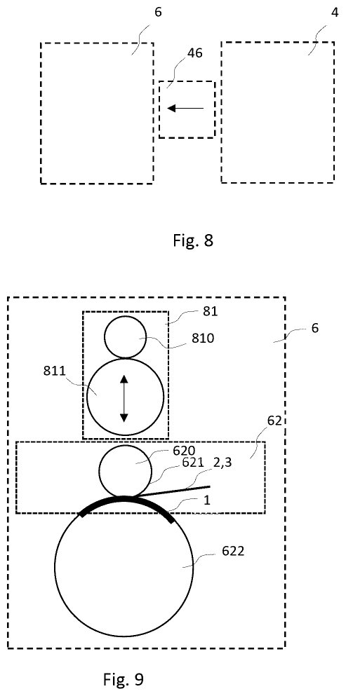

FIG. 6a shows an anilox roller 9, such as is also used for example in a first transfer unit 41 of the previously described figures, with an engraving 90. The engraving 90 is in particular arranged and/or introduced on the lateral surface of the anilox roller 9.

FIG. 6b shows an example of a detail of the lateral surface of the anilox roller 91 with an engraving 90, as is described in FIG. 6a.

Such an engraving 90 preferably has wells 911 and bars 912. The wells here preferably take up the adhesion promoter 5, in particular from the chamber doctor blade system 42, and are at least partially emptied during the transfer of the adhesion promoter 5 to the transfer medium 411.

Bars are preferably raised regions on the lateral surface of the anilox roller 9. Wells are preferably recessed regions on the lateral surface of the anilox roller 9. The doctor blades of the chamber doctor blade system 42 preferably press on the bars, with the result that the adhesion promoter 5 is scraped off them. In particular with the aid of a counter-rotating doctor blade, preferably less frequently under squeezing pressure, the anilox roller surface, thus preferably the bars, is freed of protruding first adhesion promoter 5. Thus, a defined and thus controllable quantity of adhesion promoter remains only in the recesses, thus in particular in the wells. The anilox roller 9 transfers the adhesion promoter 5 to the transfer medium 411, preferably because the recesses always empty uniformly. In particular, however, the emptying is never complete, and an adhesion promoter purging preferably takes place inside the wells during each rotation of the anilox roller 9. Through the rotation of the anilox roller 9 and the uniform take-up and removal of the first adhesion promoter 5 preferably accompanying it, the first transfer unit 41 is preferably supplied with a defined and reproducible adhesion promoter volume.

FIG. 6c shows three wells with equal pick-up volume 901, the emptying volumes 902 of which differ. The wells are also called cells for example.

The spatial volume of the cells underneath the bar overlay is preferably described by the pick-up volume. The item of volume data is in particular a theoretical value and is not identical to the actual emptying behavior of the cells. For example, a varying emptying is effected in the case of different cell shape, but identical grid width and identical volume. In addition, in particular, factors such as rheological properties of the adhesion promoter 5 and/or a printing ink, and for example its color, surface tension, printing infeed, speed, printing substrate, which here is preferably formed by the substrate, and further influencing factors have an influence on the actual pick-up volume of the anilox roller 9. In particular, the wells 911 located on the anilox roller surface represent an influencing factor for the pick-up volume through their geometry and distribution. For example, they indicate substantially what quantity of a liquid and/or the adhesion promoter 5 is taken up by the anilox roller 9, transported further to the transfer medium 411 and released again onto the surface of the substrate 1.

In particular, the above-described advantage is hereby achieved that the printing device, in particular offset printing device, can process a larger range of printing inks and/or adhesion promoters.

It is thus expedient that the anilox roller 9 has a pick-up volume in the range of from 10 cm³/m² to 30 cm³/m², in particular in the range of from 15 cm³/m² to 25 cm³/m², and/or in the range of from 6.45 BCM to 19.35 BCM, in particular in the range of from 9.67 BCM to 16.12 BCM. BCM is preferably the abbreviation for billion cubic microns. In particular, one BCM corresponds to 1.55 cm³/m². The deposition volume is for example 22 cm³/m² and/or 14 BCM. The glue density is for example 1 g/ml. One milliliter (ml) corresponds in particular to one cubic centimeter (cm³). One cubic centimeter per square meter (cm³/m²) preferably corresponds to 1 μm of layer thickness. Further data are given in particular in g/m² or ml/m².

The emptying volume and/or deposition volume from the anilox roller 9 to the first transfer medium 411 preferably corresponds to the deposition volume of the first adhesion promoter 5 on the substrate 5.

Further, it is expedient that the first adhesion promoter 5, in particular measured before, during or after the transfer of the first adhesion promoter 5 to the substrate 1 and/or before the application of the transfer ply 2 to the substrate 1, has a sufficiently high surface tension.

It is possible for the grid width of the anilox roller 9 to lie preferably in a range of from 20 L/cm to 200 L/cm, in particular in a range of from 40 L/cm to 100 L/cm, preferably in a range of from 40 L/cm to 80 L/cm. A deposition of the adhesion promoter 5 over the whole surface of the transfer medium 410, in particular the outer layer 4112 of the transfer medium, preferably on its one or more motifs, is advantageously made possible hereby. The grid width is preferably also called ruling. The grid width here is for example 80 L/cm.

Further, it is advantageous that the anilox roller 9 has an engraving angle in the range of from 30° to 90°, in particular in the range of from 45° to 60°. Here, the anilox roller has for example an engraving angle of 60°.

The engraving angle is preferably calculated as the angular position relative to the roller axis, in particular in a view from above. The engraving angle is in particular determined by measuring the angle between a line parallel to the anilox roller axis and a straight line which follows contiguous bars and/or a contiguous series of wells.

The anilox roller 9 is for example a ceramic anilox roller and/or a chrome anilox roller. Here, the roller blank and/or base body is in particular made of steel, stainless steel and/or fiber-reinforced plastic and the surface which in particular bears the grid and/or the engraving is preferably made of chrome or ceramic. Here, it is possible for a copper layer to be electroplated onto the roller blank and in particular for only an outermost protective layer made of chrome and/or ceramic to be applied.

Chrome anilox rollers preferably have grid finenesses of up to 200 L/cm. It is also conceivable that in particular ceramic anilox rollers with a grid width in the range of from 500 L/cm to 600 L/cm are used.

The engraving has in particular one or more of the engraving types selected from truncated pyramids, cell, spherical cap, hachure, in particular line structure, hachure with wells and/or hexagonal shape.

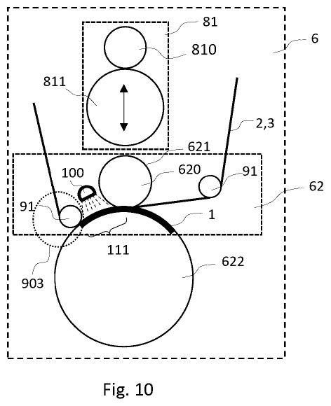

FIG. 7 shows the first printing unit 4 described in FIG. 4, in particular with an anilox roller 9 described in FIGS. 6a to 6c, except that the first printing unit 4 comprises the precuring device 101.

It is thus possible for the first printing unit 4 to comprise a precuring device 101 which is arranged in such a way that, after, in particular immediately after, preferably 0.05 s to 0.2 s after, the transfer of the first adhesion promoter 5 to the substrate 1 and/or before the application of the transfer ply 2 to the substrate 1 with the first adhesion promoter 5 transferred in the first region 11, the precuring device 101 precures the first adhesion promoter 5.

FIG. 7 thus describes in particular that the first printing unit 4 comprises the precuring device 101, wherein the following step is implemented:
precuring the first adhesion promoter 5 after, in particular immediately after, preferably 0.05 s to 0.2 s after, the transfer of the first adhesion promoter 5 to the substrate 1 and/or before the application of the transfer ply 2 to the substrate 1 with the first adhesion promoter 5.

Preferably, the precuring is carried out in such a way and/or the precuring device 101 is formed in such a way that the power of the precuring device 101, in particular the gross irradiance, lies in a range of from 2 W/cm² to 5 W/cm². The net irradiance preferably lies in a range of from 0.7 W/cm² to 2 W/cm² and/or the energy input by the precuring device into the first adhesion promoter 5 lies in a range of from 8 mJ/cm² to 112 mJ/cm². It is hereby achieved that the first adhesion promoter 5 undergoes the desired viscosity increase, but is not completely full-cured, with the result that, when the transfer ply 2 is applied to the substrate 1, the necessary adhesive action of the adhesion promoter 5 is preserved.

The precuring of the first adhesion promoter 5 is preferably effected with an exposure time of from 0.02 s to 0.056 s. At the mentioned processing speeds and/or transport speeds of the substrate 1 and the specified irradiances, the necessary energy input for the precuring is thus ensured.

It is expedient if, during the precuring of the first adhesion promoter 5, its viscosity increases to and/or by 200 mPa·s to 400 mPa·s. Such a viscosity increase guarantees that the adhesion promoter 5 is not squeezed during the application of the transfer ply 2 to the substrate 1, with the result that, after the peeling-off, the transfer ply 2 substantially remains on the substrate 1 with the resolution achieved during the printing of the first adhesion promoter 5.

In particular, it is also possible for the second printing unit and/or the conveyor element to comprise such a precuring device and/or for the corresponding step of precuring by means of a precuring device of the second printing unit to be carried out during the method.

After the transfer to the substrate 1, the first adhesion promoter 5 is hereby fixed very quickly through the precuring, with the result that an undesired running or spreading of the adhesion promoter 5 is largely prevented and the resolution is as well preserved as possible. For example, it is advantageously possible for the first adhesion promoter 5 to be smoothed on the surface by a running, but for a running that is too strong, with a negative influence on the resolution, to be suppressed or reduced by the precuring or the precuring device 101.

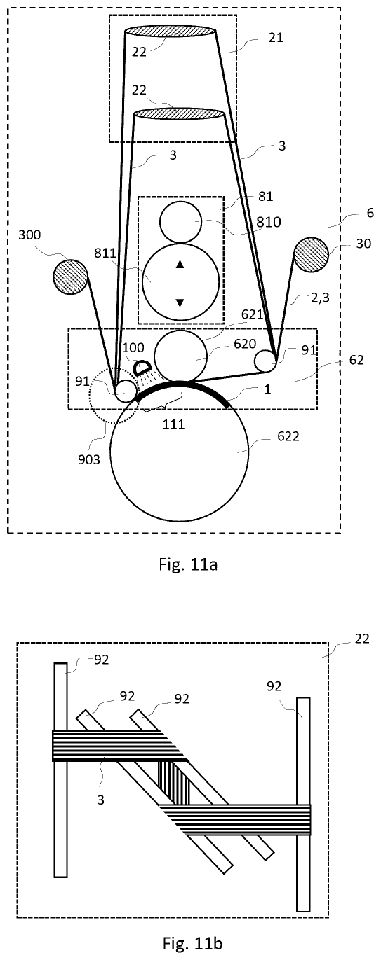

FIG. 8 shows the first printing unit 4 and the second printing unit 6, as well as a conveyor element 46.

It is thus expedient that the printing device has a second printing unit 6, in particular which is connected to the first printing unit 4 via the conveyor element 46. The conveyor element 46 preferably conveys the substrate 1 in particular from the first printing unit 4 to the second printing unit 6.

In the second printing unit 6, the application of the transfer ply 2 of the transfer film 3 to the substrate 1 with the first adhesion promoter 5 is preferably carried out in the first region 11.

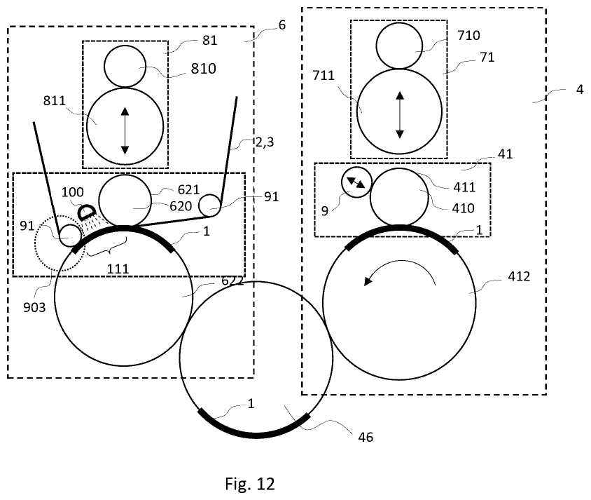

FIG. 9 shows the second printing unit 6. The second printing unit 6 optionally has the second inking unit 81, which has the second inking roller 810 and the second plate cylinder 811. The second inking unit 81 can preferably be coupled and decoupled. For the second inking unit and/or dampening unit, by “can be coupled and decoupled” is meant in particular that a connection to the pressing blanket 621 and/or the pressing cylinder 620 or preferably an offset printing blanket, which makes a transfer of an adhesion promoter 5, in particular the first and/or second adhesion promoter, and/or a printing ink, from the component that can be coupled and decoupled to the pressing blanket 621 and/or the pressing cylinder 620 or preferably an offset printing blanket possible, can be produced and removed. At least the second plate cylinder 811 and/or the second inking unit 81 is preferably formed displaceable and/or rotatable and/or removable.

FIG. 9 further describes by way of example that the second printing unit 6 preferably has the second transfer unit 62 and the second substrate cylinder 622. The second transfer unit comprises the pressing cylinder 620 with the pressing blanket 621 and is designed in such a way that the transfer ply 2 is applied, from the pressing blanket 621, to the substrate 1 with the first adhesion promoter 5 transferred in the first region 11.

FIG. 9 herewith also shows in particular that the method further comprises the following step, in particular after the transfer of the first adhesion promoter 5 to the substrate 1:
applying the transfer ply 2 to the substrate 1 by means of the second printing unit 6, which has a second transfer unit 62 comprising a pressing cylinder 620 with a pressing blanket 621 and a second substrate cylinder 622. The transfer ply 2 is applied, from the pressing blanket 621, to the substrate 1 with the first adhesion promoter 5 transferred in the first region 11.

In particular, the substrate 1 with the first adhesion promoter 5 here is fed through a gap between the pressing blanket 621 and the second substrate cylinder 622.

Further, it is expedient that one or more bearer rings are arranged on the pressing cylinder 620. The compression of the machine preferably lies between 0.0 mm and 0.1 mm. The pressing blanket is thus preferably compressed at least in regions by 0.0 mm to 0.1 mm during the transfer of the first adhesion promoter 5 to the substrate 1.

Here, it is possible for the application of the transfer ply 2 to the substrate 1 with the first adhesion promoter 5 transferred in the first region 11 to be carried out with a contact pressure.

The pressing blanket 621 and/or the second substrate cylinder 622 expediently generates a contact pressure, in particular on the substrate 1 with the first adhesion promoter 5 transferred in the first region 11 and/or the transfer ply 2, during the application of the transfer ply 2 to the substrate 1 with the first adhesion promoter 5 transferred in the first region. The contact pressure is preferably settable via the spacing of the pressing blanket 621 and the second substrate cylinder 622 and/or is set via this spacing. This spacing lies in particular in the range of from −0.5 mm to +0.75 mm, preferably in the range of from −0.1 mm to +0.3 mm and/or can be set in this range. These negative and positive values relate in particular to a basic setting of the substrate cylinder, preferably of the second substrate cylinder 622, relative to the pressing cylinder 620, in particular relative to the surface of the pressing blanket 621, preferably also taking the layer size and/or layer thickness of the substrate 1 into account. From this basic setting, the pressure on the substrate 1 can now be reduced, in particular by setting negative values, e.g. −0.1 mm, and/or be increased, in particular by setting positive values, e.g. +0.3 mm.

In particular, the pressing blanket 621 has a hardness in the range of from 50 Shore A to 90 Shore A, in particular in the range of from 70 Shore A to 90 Shore A. Further, the pressing blanket 621 preferably has a thickness in the range of from 1.5 mm to 2.5 mm, in particular in the range of from 1.71 mm to 1.96 mm.

These data preferably relate to different pressing blankets, in particular in the form of rubber blankets, and are in particular to be seen in the combination. For example, for the proof printing blanket 621, the properties from the following table are conceivable in particular:

| | | | Day | Ebony |
|---|---|---|---|---|
| | Superpress | Irio | 8212 | HC |
| Supplier | Streb | Vulcan | Flint | Continental |
| Color | Black | White | Blue | Black |
| Thickness | 1.85 mm | 1.7 mm | 1.98 mm | 1.95 mm |
| Hardness | 88 Shore | 65 Shore | 81 Shore | 55 Shore |
| Properties | Preferably used | Preferably used | Preferably | Preferably |
| | for fine to | for solid areas | used for | used for |
| | finest details, | and rough | solid areas | solid areas |
| | grids, lines. | undercoats and | and in | and in |
| | | in particular for | particular for | particular |
| | | fine details. | a particularly | for rougher |
| | | | high gloss. | undercoats. |

It is also possible for the pressing blanket 621 to have the properties from the following table:

| | | | | | |
|---|---|---|---|---|---|
| Thickness in mm | 1.85 | 1.71 | 1.96 | 1.96 | 1.96 |
| Shore A hardness | 88 | 65 | 65 | 81 | 55 |

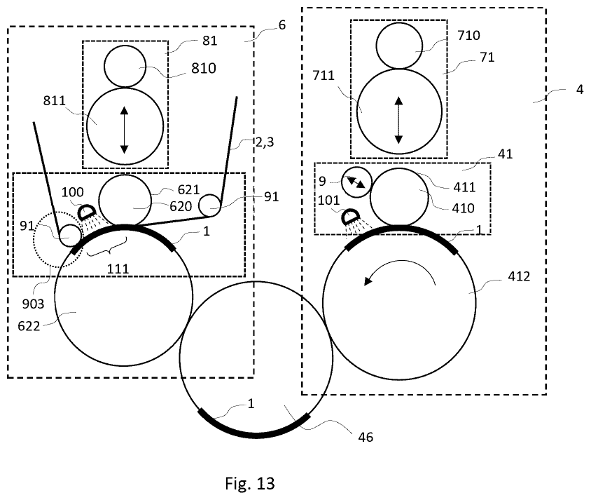

FIG. 10 shows in particular the printing unit 6 described in FIG. 9, except that the deflecting rollers 91 and the curing device 100 are additionally shown here. Further, the optional peeling-off device 903 is shown.

It is thus expedient that the second printing unit 6 comprises the curing device 100 for curing the first adhesion promoter 5. It is further possible for the following step to be carried out, in particular after the first adhesion promoter 5 has been transferred to the substrate 1:
curing the first adhesion promoter 5 by means of the curing device 100.

Further, it is preferably shown that the curing device 100 is arranged on the second substrate cylinder 622, in particular in such a way that the substrate 1 is arranged between the curing device 100 and the second substrate cylinder 622 during the curing of the first adhesion promoter 5. However, it is also conceivable that the curing device 100 is arranged on the first substrate cylinder 412 and/or on the conveyor element 46, in particular in such a way that the substrate 1 is arranged between the curing device 100 and the second substrate cylinder 622 during the curing of the first adhesion promoter 5.

Preferably, the curing is carried out in such a way and/or the curing device 100 is formed in such a way that the power of the curing device 100, in particular the gross irradiance, lies in a range of from 160 W/cm² to 220 W/cm², preferably for mercury vapor lamps, and/or from 12 W/cm² to 20 W/cm², preferably for UV LED lamps. Preferably, the net irradiance lies in a range of from 4.8 W/cm² to 8 W/cm² and/or the energy input by the curing device 100 into the first adhesion promoter 5 lies in the range of from 200 mJ/cm² to 900 mJ/cm².

The power, in particular the gross irradiance, of the curing device 100 in one or more individual impulses, in particular in two individual impulses, preferably lies in each case in a range of from 160 W/cm² to 200 W/cm², preferably for mercury vapor lamps, and/or from 12 W/cm² to 20 W/cm², preferably for UV LED lamps.

The curing of the first adhesion promoter 5 is preferably effected with an exposure time of from 0.04 s to 0.15 s. At the mentioned processing speeds and/or transport speeds of the substrate 1 and the specified irradiances, the necessary energy input for the curing is thus ensured.

It is expedient here that the curing device 100 cures the first adhesion promoter 5 on a curing section 111 of between 10 cm and 60 cm, in particular between 15 cm and 25 cm and/or between 20 cm and 30 cm, in particular wherein the curing section 111 comprises one or more first deflecting rollers 91, which are designed in such a way that they convey the substrate 1 with the transfer film 3 along the curing section 111. Here, for example, the deflecting roller 91 of the peeling-off device 903 preferably also forms a deflecting roller of the curing section 111.

It is thus possible for the first adhesion promoter 5 to be cured on a corresponding curing section 111, in particular wherein the substrate 1 with the transfer film 3 is conveyed over the curing section 111 by means of one or more first deflecting rollers 91.

Further, it is possible in particular for the substrate 1 with the adhesion promoter 5 to be conveyed together with the transfer film 3 over a section in a range of from 10 cm to 60 cm, in particular from 10 cm to 40 cm, preferably from 15 cm to 20 cm, in particular before the carrier film 31 of the transfer film 3 is peeled off.

Further, it is possible for the first adhesion promoter 5 to be cured by means of the curing device 100 after, in particular immediately after, preferably 0.05 s to 0.2 s after, the transfer of the transfer ply 2 to the substrate 1 with the first adhesion promoter transferred in the first region 11. It is herewith possible for the curing device 100 to be designed in such a way that it cures the first adhesion promoter 5 after, in particular immediately after, preferably 0.05 s to 0.2 s after, the transfer of the transfer ply 2 to the substrate 1 with the first adhesion promoter 5 transferred in the first region 11. The periods of time specified here are preferably based on the previously mentioned examples, preferably with a section of 0.2 m between film deposition, in particular the application of the transfer ply to the substrate, and curing, for example at 8,000 to 20,000 sheets per hour.

The first adhesion promoter 5 is preferably cured by means of irradiation during the curing, and in particular is irradiated through the transfer film 3, preferably through the carrier film 31 and/or the transfer ply 2 of the carrier film 31.

Further, FIG. 10 shows the possibility in particular that the printing device, in particular the second printing unit 6, comprises a peeling-off device 903. The peeling-off device 903 is preferably formed in such a way that the carrier film 31 of the transfer film 3 is peeled off, wherein the transfer ply 2 remains on the substrate 1 in the first region 11.

It is herewith possible for the printing device, in particular the second printing unit 6, to comprise the peeling-off device 903, wherein the following step is implemented:
peeling off the carrier film 31 of the transfer film 3, in such a way that the transfer ply 2 remains on the substrate 1 in the first region 11.

This means in particular that the transfer ply 2 only remains on the substrate 1 where the first adhesion promoter 5 is being and/or has been transferred.

For the peeling-off, the peeling-off device 903 has for example rollers and/or deflecting rollers, for example the deflecting roller 91. Further, it is possible for the peeling-off device 903 to comprise separating blades for example.

It is possible for the peeling-off device to be formed in such a way that a carrier film of the transfer film 3 is peeled off, wherein the transfer ply 2 remains on the substrate 1 where adhesion promoter is applied to the substrate 1, and the transfer ply 2 is peeled off with the carrier film 31 where no adhesion promoter is applied to the substrate 1.

During the peeling-off it is possible for a small quantity of adhesion promoter, transfer ply 2 and/or further applied materials, such as printing ink, to be peeled off as well in an undesired manner. This quantity is advantageously particularly small here.

Further, it is shown for example that the curing device 100 is arranged, in particular in the conveying direction of the substrate 1, before the peeling-off device 903 and/or after the first transfer unit 41, in particular the transfer medium 411.

It is expedient that the curing, in particular in the conveying direction of the substrate 1, is carried out before the peeling-off of the transfer film 3 and/or after the transfer of the first adhesion promoter 5 to the substrate 1.

FIG. 11a shows the second printing unit 6 described in FIG. 10, except that a deflection device 21 with two deflection stations 22 is further shown, as well as the supply roll 30 and the take-up roll 300.

It is herewith possible for the second printing unit 6 to comprise a deflection device 21 with one or more deflection stations 22. The deflection device 21 is formed in such a way that the transfer ply 2 is fed through between the pressing cylinder 620 and the second substrate cylinder 622 repeated one or more times. In particular, the transfer ply 2 is applied to the substrate 1 repeated one or more times here and/or the carrier film 31 of the transfer film 3 is peeled off at least partially repeated one or more times and the transfer ply 2 at least partially remains on the substrate 1 with the first adhesion promoter 5 in the first region 11.

It is thus expedient that the second printing unit 6 comprises a deflection device 21 with one or more deflection stations 22, wherein the transfer ply 2 is fed through between the pressing cylinder 620 and the second substrate cylinder 622 by means of the deflection device 21 repeated one or more times, in particular wherein the transfer ply 2 is applied to the substrate 1 repeated one or more times and/or the carrier film of the transfer film is at least partially peeled off repeated one or more times and the transfer ply at least partially remains on the substrate 1 with the first adhesion promoter 5 in the first region 11.

The deflection device 21 is preferably arranged behind the peeling-off device 903 in the conveying direction. The carrier film 31 of the transfer film 3 is hereby preferably peeled off of the substrate, wherein the transfer ply 2 remains on the substrate with the first adhesion promoter 5 in the first region 11 and the transfer ply 2 with the carrier film 31 is peeled off of the substrate 1 outside the first region. In particular by then displacing the transfer ply 2 laterally by the deflection device 21, the transfer ply 2 peeled off as well can thus be recycled.

FIG. 11b shows by way of example a top view of one of the deflection stations 22 shown in FIG. 11a. Here, the deflection device preferably comprises one or more deflection stations 22, which comprise for example two or more further deflecting rollers, of which at least two further deflecting rollers 92 are arranged parallel to each other and are arranged at an angle, in particular not equal to 0°, preferably at an angle of 45°, in particular in relation to the principal direction of movement of the transfer ply 2. The transfer film 3 is preferably unwound from the supply roll 30, pulled in between the pressing cylinder 620 with the proof printing blanket 621 and the second substrate cylinder 622, and then transported with the substrate 1 so far that the first adhesion promoter 5 can be cured, in particular through the transfer film 3. The transfer film 3 is then returned again by means of deflecting rollers 92 and again pulled into the gap, in particular also called printing nip, between the pressing cylinder 620 with the proof printing blanket 621 and the second substrate cylinder 622.

The transfer ply 2 is thereby applied to the substrate 1 advantageously offset transverse to the conveying direction, in particular in relation to the position of the transfer ply 2 during a previous application of the transfer ply 2 to the substrate 1, during a repeated feed through between the pressing cylinder 620 with the pressing blanket 621 and the second substrate cylinder 622. In other words, a lateral displacement of the transfer ply 2 is preferably carried out hereby.

If only one transfer film roll 30 is used, it is advantageous to return the transfer film 3 up to twice and to apply the transfer ply 2 from the transfer film 3 to the substrate again. In this case, for example three webs can be covered with transfer ply 2. Further, it is possible for two supply rolls 30 with one transfer film 3 in each case to be used. It is possible in particular for both transfer films 3 of the two supply rolls 30 to be returned once. Thus, four webs can then be decorated with transfer ply 2. In other words, four webs, namely in each case two webs consisting of one of two transfer plies, are preferably applied to the substrate 1 with the first adhesion promoter 5, wherein the two transfer films 3 are each returned once, and thereby, in particular four times, in each case one web of a transfer ply 2 remains on the substrate 1, if at least the carrier film 31 is peeled off and/or deflected.

This method and this device is particularly advantageous in particular as the transfer film is optimally utilized, in particular if only small regions are decorated, such as for example in the case of the decoration of packaging. Here, it is also possible for the multiple application of the transfer ply to one or more substrates to take place.

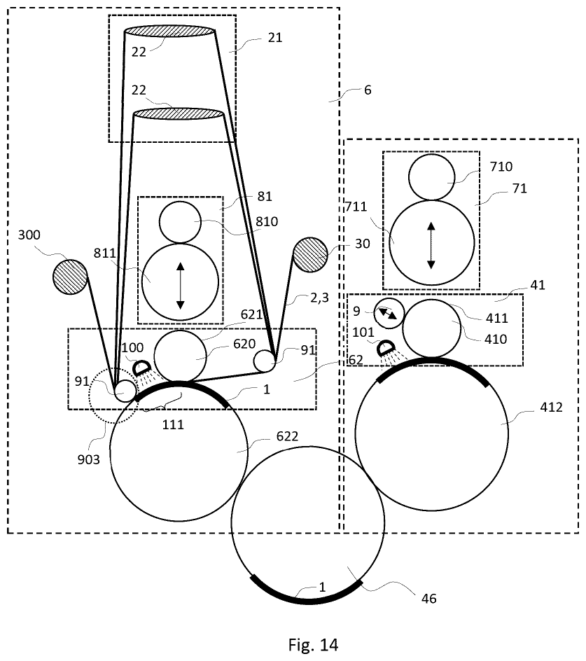

FIG. 12 shows a printing device, with the second printing unit 6 described in FIG. 10 and the first printing unit 4 described in FIG. 7, which are preferably connected to each other via the conveyor element 46. Here, the substrate is preferably conveyed from the first printing unit 4 to the second printing unit 6 via the conveyor element 46.

It is conceivable here for example that the conveyor element 46 is a conveyor section for conveying the substrate 1, in particular wherein the substrate 1 is processed in the form of rolls. It is furthermore possible for the conveyor element 46 to be a drum, in particular with substrate holders, for conveying the substrate 1, in particular wherein the substrate 1 is processed in the form of sheets. It is also possible for the conveyor element 46 to comprise further structural elements in addition to the drum, for example several drums, guiding elements or other structural devices, which can in particular be driven or not driven.

Here, the curing device 100 is arranged on the second substrate cylinder 622, wherein the substrate 1 is arranged between the curing device 100 and the second substrate cylinder 622 during the curing of the first adhesion promoter 5.

FIG. 13 shows the printing device described for FIG. 10, wherein the precuring device 101 for example also described for FIG. 7 is additionally shown.

It is possible for the curing and/or the precuring to be carried out by means of an irradiation, selected from the group: UV irradiation, in particular by means of high pressure UV mercury vapor lamp, medium pressure UV mercury vapor lamp, low pressure UV mercury vapor lamp, low energy UV and/or UV LED, and/or electron beams (E-Beam) or a combination thereof.

The curing device 100 and/or the precuring device 101 expediently preferably comprises one or more emitters selected from the group: UV emitters, in particular high pressure UV mercury vapor lamps, medium pressure UV mercury vapor lamps, low pressure UV mercury vapor lamps, low energy UV and/or UV LED, and/or electron beams (E-Beam) or a combination thereof.

The curing device 100 and/or the precuring device 101 preferably irradiates the substrate 1 and/or the first adhesion promoter 5 with a wavelength in the range of from 250 nm to 410 nm, in particular in the range of from 310 nm to 410 nm, and/or in the range of from 365 nm to 405 nm. It is expediently possible for the substrate 1 and/or the first adhesion promoter 5 to be irradiated with a wavelength in the range of from 250 to 410 nm, in particular in the range of from 310 nm to 410 nm, and/or in the range of from 365 nm to 405 nm, during the curing and/or during the precuring.

FIG. 14 shows the printing device described in FIG. 13, except that the deflection device 21, as described in FIGS. 11a and 11b, with the deflection stations 22, and the supply roll 30 and the take-up roll 200 are further shown.

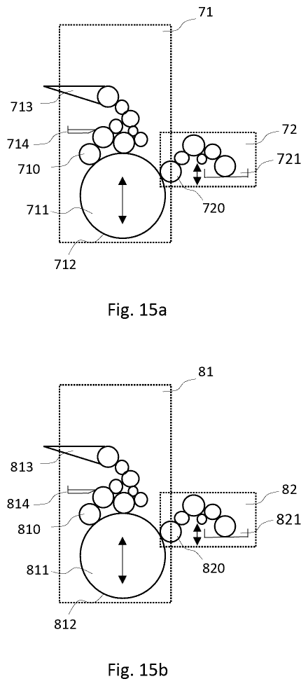

FIG. 15a and FIG. 15b show the first and second inking unit 71, 81.

The first inking unit 71 here is connected to the first dampening unit 72, in particular via the at least one first dampening roller 720. The first inking unit 71 has in particular several first inking rollers 710, a first ink duct 713 and an optional doctor blade 714.

The second inking unit 81 here is connected to the second dampening unit 82, in particular via the at least one second dampening roller 820. The second inking unit 81 has in particular several second inking rollers 810, a second ink duct 813 and an optional doctor blade 814.

If the second inking unit 81 is in a decoupled state, then it is also possible for the second printing plate 812 not to be arranged on the second plate cylinder 811. If the first inking unit 71 is in a decoupled state, then it is also possible for the first printing plate 712 not to be arranged on the first plate cylinder 711.

It is herewith possible for the first printing unit 4 to have a first inking unit 71 that can be coupled and decoupled and comprises at least one first inking roller 710 and a first plate cylinder 711 and/or for the second printing unit 6 to have a second inking unit 81 that can be coupled and decoupled and comprises at least one second inking roller 810 and a second plate cylinder 811.

Further, it is possible for the first printing unit 4 to have a first dampening unit 72 that can be coupled and decoupled and comprises at least one first dampening roller 720 and/or for the second printing unit 6 to have a second dampening unit 82 that can be coupled and decoupled and comprises at least one second dampening roller 820.

The first dampening unit 72 can preferably be coupled to and decoupled from the transfer cylinder 410 and/or the transfer medium 411 together with the first inking unit 71. The second dampening unit 82 can preferably be coupled to and decoupled from the pressing cylinder 620 and/or a printing blanket, in particular arranged on the pressing cylinder 620, together with the second inking unit 81.

It is thus conceivable that the first inking unit 71 is formed, in a coupled state of the first inking unit 71, in such a way that the first inking unit 71 transfers a second adhesion promoter to the transfer medium 411. It is thus possible for a second adhesion promoter to be transferred to the transfer medium 411 by means of the first inking unit 71 in a coupled state of the first inking unit 71.

It is expedient that the second adhesion promoter 52 is transferred from the transfer medium 411 to the substrate 1 with the first adhesion promoter 5. Here, the second adhesion promoter is transferred to the transfer medium and/or the substrate preferably in a second region, which partially overlaps and/or does not overlap the first region. In particular, it is also possible here for the second adhesion promoter to be precured by means of the precuring device 101 and/or to be cured by means of the curing device 100.

An advantage is in particular achieved in that, depending on the requirements of a product to be produced, the printing device is flexibly settable. For example, the second adhesion promoter can be used when a more absorbent substrate 1 is used and/or the first adhesion promoter 5 can be used in the case of a higher desired gloss of the transfer film 3.

Further, for example, the advantage is achieved that, because of the above-described effects of the flow properties and deformation properties of an adhesion promoter on the gloss, various gloss effects, in particular with particularly large gloss differences, can be generated in various regions of the applied transfer ply 2. In particular, the second adhesion promoter here is an offset cold film glue and/or has non-Newtonian or almost non-Newtonian behavior. As a result, for example, a particularly appealing optical appearance is generated and/or the protection against forgery is increased.

It is also conceivable that a printing ink, in particular offset printing ink, is transferred to the substrate 1 by means of the first and/or second inking unit 71, 81.

Here, in particular, it is possible for a printing ink, in particular offset printing ink, to be transferred to the transfer medium 411 and/or to a printing blanket arranged on the transfer cylinder 410 by means of the first inking unit 71 and to be transferred to the substrate 1 with or without the first adhesion promoter 5.

It is thus conceivable that, by means of the first printing unit 4, the first adhesion promoter 5 in the form of a flexographic printing glue and/or a flexographic printing ink and the second adhesion promoter in the form of an offset printing glue and/or an offset printing ink is transferred to the substrate 1.

By means of the second inking unit 81, in particular the second printing plate 812, a printing ink, in particular offset printing ink, is for example transferred to a printing blanket arranged on the pressing cylinder 620, wherein it is also conceivable that the transfer ply 2 here is not applied to the substrate 1 by means of the second printing unit 6.

It is expedient that one or more of the following steps are carried out, in particular are carried out one or more times in any order:
coupling or decoupling the first inking unit 71 and/or the first dampening unit 72,
coupling or decoupling the second inking unit 81 and/or the second dampening unit 82,
coupling or decoupling the anilox roller 9, in particular together with the chamber doctor blade system 42, and/or the chamber doctor blade system 42.

Further, for example, the resource efficiency of a printing device, in particular offset printing device, is hereby increased, because the transfer cylinder takes on a dual function.

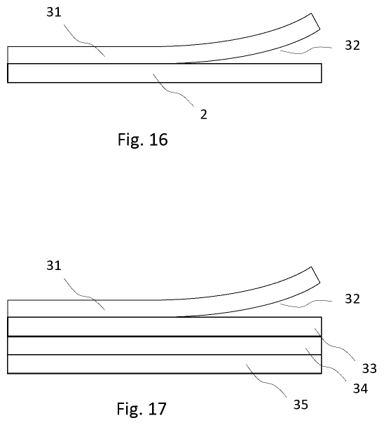

FIG. 16 schematically shows a cross section through a transfer film 3 with a carrier film 31, a transfer ply 2 and an optional detachment layer 32.

The carrier film 31 here is preferably a PET film, preferably with a thickness of 12 μm.

FIG. 17 shows the transfer film 3 described in FIG. 16, wherein the transfer ply 2 has a protective varnish layer 33, a metallization 34 and an adhesive layer 35, in particular an adhesion-promoter layer 35.

Here, the carrier film 31 is coated with the detachment layer 32 and the protective varnish 34, and the protective varnish layer is vaporized with metal under high vacuum to form the metallization 34, in particular aluminum. The adhesive layer 35, in particular which establishes a bond with the substrate during the application of the transfer ply 2 to the substrate 1, is then applied to the metallization 35. In addition to the layers shown, in particular, still further layers can be arranged, for example further adhesion-promoter layers, vaporizable layers, barrier layers and/or colored varnish layers.

The transfer ply 2 is preferably encompassed by the transfer film 3, which has the following layers, and this has, in particular in the specified order in cross section: the carrier film 31, the optional detachment layer 32, the transfer ply 2.

Further, the transfer ply 2 preferably has one or more of the following layers, in particular in the specified order in cross section: a protective varnish layer 33 on a side of the transfer ply 2 facing the carrier film 31 in the transfer film 3, a replication varnish layer, a colored varnish layer, a vaporizable varnish layer, a metal layer 34, in particular an aluminum layer, an adhesion-promoter layer, a barrier layer, a glue layer 35 on a side of the transfer ply 2 facing away from the carrier film 31 in the transfer film 3. Thus, it is possible for example for the transfer film 3 to be a cold stamping film.

As shown in FIG. 16 and FIG. 17, the carrier film 31 is detachable from the transfer ply 2.

For example, a cold transfer film from LEONHARD KURZ Stiftung & Co. KG is used as transfer film, which in particular has a transfer ply with at least one vaporizable varnish layer, a metal layer vapor-deposited thereon and an adhesion-promoter layer. The transfer ply 2 can additionally have still further layers, such as for example a detachment layer, at least one protective layer, barrier layers, ink layers, further glue layers, further adhesion-promoter layers.

### LIST OF REFERENCE NUMBERS

1 substrate
11 first region
100 curing device
101 precuring device
111 curing section
2 transfer ply
21 deflection device
22 deflection stations
3 transfer film
31 carrier film
32 detachment layer
33 protective varnish layer
34 metal layer
35 adhesive layer
30 supply roll
300 take-up roll
31 carrier film
4 first printing unit
41 first transfer unit
410 transfer cylinder
411 transfer medium
4111 carrier plate
4112 outer layer
412 first substrate cylinder
42 chamber doctor blade system
46 conveyor element
5 first adhesion promoter
52 second adhesion promoter
53 third adhesion promoter
6 second printing unit
62 second transfer unit
620 pressing cylinder
621 pressing blanket
622 second substrate cylinder
71 first inking unit
710 first inking roller
711 first plate cylinder
712 first printing plate
713 first ink duct
714 doctor blade
72 first dampening unit
720 first dampening roller
721 first water tank
81 second inking unit
810 second inking roller
811 second plate cylinder
812 second printing plate
813 second ink duct
814 doctor blade
82 second dampening unit
820 second dampening roller
821 second water tank
9 anilox roller
90 engraving
901 volume
902 emptying volume
911 well
912 bar
903 peeling-off device
91 first deflecting rollers
92 second deflecting rollers

1. An offset printing device for transferring a transfer ply of a transfer film to a substrate, the offset printing device having a first printing unit, the first printing unit comprising:
a first transfer cylinder having a transfer medium on an outer surface of the transfer cylinder, the transfer medium having one or more raised regions forming at least one motif;
a first substrate cylinder for feeding the substrate through a gap formed between the first transfer cylinder and the first substrate cylinder;
an anilox roller for transferring a first adhesion promoter to the transfer medium of the first transfer cylinder, the anilox roller being displaceable between a coupled position in which a connection is provided between the anilox roller and the transfer medium and a decoupled position in which the connection between the anilox roller and the transfer medium is removed, the anilox roller being inoperable in the decoupled position; and
a first inking unit having at least one inking roller and a first plate cylinder for transferring an ink to the transfer medium of the first transfer cylinder, the first inking unit being displaceable between a coupled position in which a connection is provided between the first inking unit and the transfer medium and a decoupled position in which the connection between the first inking unit and the transfer medium is removed, the first inking unit being inoperable in the decoupled position,
wherein the first transfer cylinder is designed in such a way that the first adhesion promoter or the ink provided on the one or more raised regions of the outer transfer medium is transferred from the transfer medium to a first region of the surface of the substrate in a pattern of the at least one first motif.

2. The offset printing device according to claim 1, wherein the first inking unit further comprises a dampening unit having at least one dampening roller.

3. The offset printing device according to claim 1, wherein the first adhesion promoter transferred by the anilox roller to the transfer medium of the first transfer cylinder has a Newtonian behavior.

4. The offset printing device according to claim 1, wherein the first adhesion promoter has a viscosity in the range of from 200 mPa·s to 5,000 mPa·s.

5. The offset printing device according to claim 1, wherein the first adhesion promoter is transferred to the substrate with a deposition volume in the range of from 2 cm³/m² to 10 cm³/m².

6. The offset printing device according to claim 1, wherein the transfer medium has a thickness in the range of from 0.5 mm to 10 mm.

7. The offset printing device according to claim 1, wherein the at least one motif of the transfer medium has a grid width of at most 150 lpi.

8. The offset printing device according to claim 1, wherein the at least one motif of the transfer medium comprises one or more lines with a minimum line thickness of 0.05 mm.

9. The offset printing device according to claim 1, further comprising a second printing unit, the second printing unit having a second transfer unit comprising a pressing cylinder with a pressing blanket and a second substrate cylinder, wherein the second transfer unit is designed in such a way that the transfer ply is applied from the pressing blanket to the substrate with the first adhesion promoter transferred in the first region.

10. The offset printing device according to claim 1, wherein the first printing unit further comprises a chamber doctor blade system, which is formed in such a way that the first adhesion promoter is transferred from the chamber doctor blade system to the anilox roller.

11. The offset printing device according to claim 1, wherein the anilox roller has a grid width with lines per unit of extension in a range of from 20 L/cm to 200 L/cm.

12. The offset printing device according to claim 1, wherein the anilox roller has a pick-up volume in the range of from 10 cm³/m² to 30 cm³/m² and/or in the range of from 6.45 BCM to 19.35 BCM.

13. The offset printing device according to claim 1, wherein the anilox roller has an engraving angle in the range of from 30° to 90°.

14. The offset printing device according to claim 1, wherein the anilox roller has an engraving, wherein the engraving comprises one or more of the engraving types selected from truncated pyramids, cell, spherical cap, hachure and/or hexagonal shape.

15. The offset printing device according to claim 1, further comprising a second printing unit having a second inking unit that can be coupled and decoupled, the second printing unit comprising at least one second inking roller and a second plate cylinder.

16. The offset printing device according to claim 2, wherein the dampening unit can be coupled and decoupled.

17. The offset printing device according to claim 1, wherein the first inking unit is formed, in a coupled state of the first inking unit, in such a way that the first inking unit transfers a second adhesion promoter to the transfer medium.

18. The offset printing device according to claim 15, wherein the second printing unit further comprises a curing device for curing the first adhesion promoter.

19. The offset printing device according to claim 18, wherein the curing device is arranged on the first substrate cylinder.

20. The offset printing device according to claim 18, wherein the curing device cures the first adhesion promoter on a curing section of between 10 cm and 60 cm.

21. The offset printing device according to claim 1, wherein the first printing unit further comprises a precuring device which is arranged in such a way that, after the transfer of the first adhesion promoter to the substrate and/or before the application of the transfer ply to the substrate with the first adhesion promoter transferred in the first region, the precuring device precures the first adhesion promoter.

22. The offset printing device according to claim 18, wherein the curing device comprises one or more emitters selected from the group: UV emitters and/or electron beams (E-Beam) or a combination thereof.

23. A method for transferring a transfer ply of a transfer film to a substrate by means of an offset printing device according to claim 1, the method comprising:
applying a first adhesion promoter to a structure on the outermost layer of the transfer medium provided on the transfer cylinder of the first transfer unit of the offset printing device, the structure forming the at least one first motif;
feeding the substrate to the first transfer unit with the first substrate cylinder of the offset printing device; and
transferring the first adhesion promoter by means of the first transfer unit, wherein the first adhesion promoter is transferred from the transfer medium to a first region of the surface of the substrate in a pattern of the at least one first motif.

24. The method according to claim 23, wherein only a small amount of back splitting or substantially no back splitting takes place during the transfer of the first adhesion promoter from the transfer medium to the substrate.

25. The method according to claim 23, wherein the first adhesion promoter has a Newtonian behavior or an almost Newtonian behavior.

26. The method according to claim 23, further comprising:
applying the transfer ply to the substrate by means of a second printing unit, which has a second transfer unit comprising a pressing cylinder with a pressing blanket and a second substrate cylinder, wherein the transfer ply is applied from the pressing blanket to the substrate with the first adhesion promoter transferred in the first region.

27. The method according to claim 23, wherein the application of the transfer ply to the substrate with the first adhesion promoter transferred in the first region is carried out with a contact pressure, wherein the contact pressure is set via the spacing of the pressing blanket and the second substrate cylinder.

28. The method according to claim 23, wherein one or more of the following steps are carried out:
coupling or decoupling the first inking unit and/or the first dampening unit;
coupling or decoupling a second inking unit and/or a second dampening unit;
coupling or decoupling an anilox roller.

29. The method according to claim 23, wherein the printing device comprises a peeling-off device, and wherein the following step is implemented:
peeling off the carrier film of the transfer film in such a way that the transfer ply remains on the substrate in the first region.

30. The method according to claim 23, wherein the transfer ply has a smoothness of at least 200 s and/or has a surface smoothness in the range of from 0.05 μm to 1.5 μm and/or has a gloss greater than 500 GU in the case of a measurement geometry of 60° and/or greater than 100 GU in the case of a measurement geometry of 85°.

31. The method according to claim 23, wherein the substrate has a surface smoothness in the range of from 0.5 μm to 2.0 μm and/or has a gloss in the range of from 20% to 80%.

32. The method according to claim 23, wherein the substrate has a pick resistance of from 0.5 m/s to 4 m/s.

33. The method according to claim 23, wherein the substrate has a penetration behavior in the range of from 0.9 OD to 1.3 OD (OD=Optical Density).
